(19) United States
(12) Patent Application Publication
(10) Pub. No.: US 2012/0118186 A1
(43) Pub. Date: May 17, 2012

(54) Lateral Correcting Device and Prining Press

(75) Inventors: Koji Nishiyama, Hiroshima (JP); Kazuhiro Naito, Hiroshima (JP); Takanori Nitta, Hiroshima (JP); Daisuke Okawa, Hiroshima (JP); Manabu Fujike, Tokyo (JP)

(73) Assignee: Mitsubishi Heavy Industries Printing & Packaging Machinery, Ltd., Mihara-shi, Hiroshima (JP)

(21) Appl. No.: 13/381,678

(22) PCT Filed: Jun. 22, 2010
(86) PCT No.: PCT/JP2010/060548

§ 371 Date: Dec. 30, 2011

(30) Foreign Application Priority Data
Jul. 16, 2009 (JP) 2009-168044

(51) Int. Cl. B41F 13/24

(52) U.S. Cl. 101/248

(57) ABSTRACT

A lateral register correcting device includes, a first adjusting unit that comprises a plurality of the pressing members arranged in a central area in the width direction of the web, a second adjusting unit that comprises one or more of the pressing members arranged in an outer area in the width direction of the web than the first adjusting unit, and an adjusting system that can adjust a pressure amount in the central area in the width direction of the web and a pressure amount in the outer area in the width direction of the web to different values through the first and second adjusting units. The pressing members are pressure rollers in a disc shape, and the pressure rollers of the second adjusting unit have an outer diameter set larger than that of the pressure rollers of the first adjusting unit.

### FIELD

The present invention relates to a lateral register correcting device that adjusts register in a width direction of webs running between a plurality of printing units by causing the webs to be wavy, and a printing press that includes the lateral register correcting device.

### BACKGROUND

For example, a typical web offset press for newspaper includes a feeder device having a plurality of feeder units, a printing device having a plurality of printing units, a web path device, a folder having a plurality of folder units, and a delivery device. When webs are supplied from the feeder device to the respective printing units, the printing units perform printing onto the corresponding webs, the web path device changes running routes of the webs, and then the webs are superimposed in a predetermined order. The webs are longitudinally folded, laterally cut to a predetermined length, and then laterally folded by the folder. In this way, a signature is formed and delivered as a print (newspaper).

In this web offset press for newspaper, the printing device has a tower configuration in which the plural printing units are vertically arranged to enable four-color printing. A phenomenon called fan-out occurs in the tower printing device because printing is performed successively by four printing units while a web is being carried upward. That is, when the web is carried upward, the web is supplied with ink and dampening water while receiving printing pressure, which extends the web in a width direction. In this case, the web is transformed to a fan-like form due to four-color printing, and misalignment in the width direction between the web and press plates (plate cylinder) occurs. Four colors are also misaligned during a printing process of four color printing and therefore color pictures cannot be clearly printed.

A method and a device described in Patent Literature 1 below solve these problems, for example. Web-paper width adjusting method and device described in Patent Literature 1 enable to press web paper running between two printing units from one surface side at a plurality of sites spaced in a width direction to form ripples approximately parallel to a running direction of the web paper so that the web paper at an entrance of downstream one of the two pressing units has a width approximately equal to a width of the web paper at an entrance of the upstream pressing unit.

### CITATION LIST

### Patent Literature

Patent Literature 1: Japanese Patent Application Laid-open No. H06-134959

### SUMMARY

### Technical Problem

The conventional web-paper width adjusting method and device mentioned above press the web paper from one surface side at the plural sites in a state where tensions in the running direction are applied to the web paper to form the ripples on the web paper, thereby adjusting the width of the web paper. However, restraint of the tensions is insufficient at outer parts of the web in the width direction, that is, at the side parts of the web paper and accordingly it is difficult to form sufficient ripples there as compared to the central part even if the web is pressed from one surface side. Therefore, the fan-out of the web cannot be properly corrected, which lowers the print quality.

The present invention solves the problems described above and an object of the present invention is to provide a lateral register correcting device and a printing press that enable to improve the print quality by properly correcting the fan-out of the web.

### Solution to Problem

According to an aspect of the present invention, a lateral register correcting device that adjusts register in a width direction of a web by pressing a plurality of pressing members provided in the width direction of the web against the running web at least from one surface thereof to cause the web to be wavy, includes: a first adjusting unit that comprises a plurality of the pressing members arranged in a central area in the width direction of the web; a second adjusting unit that comprises one or more of the pressing members arranged in an outer area in the width direction of the web than the first adjusting unit; and an adjusting system that can adjust a pressure amount in the central area in the width direction of the web and a pressure amount in the outer area in the width direction of the web to different values through the first and second adjusting units.

Advantageously, in the lateral register correcting device, the adjusting system adjusts the pressure amount in the outer area in the width direction of the web to be larger than the pressure amount in the central area in the width direction of the web.

Advantageously, in the lateral register correcting device, the adjusting system has a first driving device and a second driving device that can independently drive the first and second adjusting units, respectively.

Advantageously, in the lateral register correcting device, the adjusting system has a first driving device that can drive the first and second adjusting units together, and a second driving device that can drive only the second adjusting unit.

Advantageously, in the lateral register correcting device, the pressing members are pressure rollers in a disc shape, and the pressure rollers of the second adjusting unit have an outer diameter set larger than that of the pressure rollers of the first adjusting unit.

Advantageously, in the lateral register correcting device, the pressing members are pressure rollers in a disc shape, and number of the pressure rollers per unit length in the second adjusting unit is set larger than number of the pressure rollers per unit length in the first adjusting unit.

Advantageously, in the lateral register correcting device, the pressing members are pressure rollers in a disc shape, and the pressure rollers in the second adjusting unit each have a roller body rotatably supported on an eccentric shaft and can change the pressure amount by changing a phase of the eccentric shaft.

Advantageously, in the lateral register correcting device, a third adjusting unit comprising one of the pressing members arranged on an outermost side in the width direction of the web is comprised, and the adjusting system can adjust a pressure amount in a central area in the width direction of the web, a pressure amount in an outer area in the width direction of the web, and a pressure amount on the outermost side in the width direction of the web to different values through the first, second, and third adjusting units.

Advantageously, in the lateral register correcting device, the plurality of pressing members are located upstream in the web running direction with respect to a printing cylinder, and the pressing members in the second adjusting unit are located nearer to the printing cylinder than the pressing members in the first adjusting unit.

Advantageously, in the lateral register correcting device, the first adjusting units are arranged at a regular interval in the central area and in the outer area on one surface side of the web, and the second adjusting unit is arranged in the outer area on the other surface side of the web.

Advantageously, in the lateral register correcting device, the pressing members each have a pressing member body in a hollow shape having a curved surface around a central axis along the width direction of the web, and an ejection hole formed on the curved surface to jet fluid contained in the pressing member body toward the web.

Advantageously, in the lateral register correcting device, the adjusting system has a control unit that can control the adjusting units, and the control unit controls the adjusting units based on web data or print data previously set.

Advantageously, in the lateral register correcting device, the adjusting system comprises a control unit that can control each of the adjusting units, and a misalignment detecting unit that detects misalignment between the web and print images, and the control unit controls the adjusting units based on a result of detection by the misalignment detecting unit.

According to another aspect of the present invention, a printing press includes: a feeder device that feeds a web from rolled paper; a printing device that comprises a plurality of printing units each performing printing on the web let out from the feeder device; a folder that cuts the web subjected to the printing by the printing device, and superimposes and folds the webs, thereby forming a signature; and a lateral register correcting device that adjusts register in a width direction of the web by pressing a plurality of pressing members provided in the width direction of the web between the plurality of printing units against the running web at least from one surface thereof to cause the web to be wavy. The lateral register correcting device includes: a first adjusting unit that comprises a plurality of the pressing members arranged in a central area in the width direction of the web; a second adjusting unit that comprises one or more of the pressing members arranged in an outer area in the width direction of the web than the first adjusting unit; and an adjusting system that can adjust a pressure amount in the central area in the width direction of the web and a pressure amount in the outer area in the width direction of the web to different values through the first and second adjusting units.

Advantageously, in the printing press includes a plate cylinder having press plates attached thereto, and a blanket cylinder facing in contact with the plate cylinder to transfer ink on the plate cylinder to the web, wherein the plate cylinder is an integrated plate cylinder to which a plurality of the press plates can be attached on an outer peripheral surface along an axial direction thereof and that can adjust positions of the press plates with respect to the web by being axially moved with respect to a frame.

### Advantageous Effects of Invention

The lateral register correcting device according to the present invention includes a first adjusting unit that includes a plurality of pressing members arranged in a central area in the width direction of a web, and a second adjusting unit that includes one or more pressing members arranged in an outer area in the width direction of the web than the first adjusting unit, and an adjusting system can adjust a pressure amount in the central area in the width direction of the web and a pressure amount in the outer area in the width direction of the web to different values through the first and second adjusting units. Because the pressure amount in the central area and the pressure amount in the outer area to the web are accordingly adjusted to the different values by the first and second adjusting units, register adjustment amounts are appropriately adjusted to almost uniform values at all positions in the width direction of the web where tensions are different from each other, and fan-out of the web can be properly corrected. As a result, the print quality can be improved.

According to the lateral register correcting device of the present invention, the adjusting system adjusts the pressure amount in the outer area in the width direction of the web to be larger than the pressure amount in the central area in the width direction of the web. Therefore, the pressure amount in the outer area of the web where the tension is lower is set larger than in the central area, thereby properly correcting the fan-out in the entire area of the web.

According to the lateral register correcting device of the present invention, the adjusting system includes a first driving device and a second driving device that can independently drive the first and second adjusting units, respectively. Therefore, by the driving devices independently driving the corresponding adjusting units, register adjustment in the central area and in the outer area in the width direction of the web can be performed separately. Accordingly, the fan-out can be properly corrected in the entire area and a fan-out correction operation can be easily performed in a short time.

According to the lateral register correcting device of the present invention, the adjusting system includes a first driving device that can drive the first and second adjusting units together and a second driving device that can drive only the second adjusting unit. Therefore, the pressure amounts in the entire area in the width direction of the web are adjusted to be uniform by the first driving device driving the first and second adjusting units together, and the pressure amount in the outer area in the width direction of the web is adjusted individually by the second driving device driving only the second adjusting unit. Accordingly, the fan-out of the web can be properly corrected and the fan-out correction operation can be easily performed in a short time.

According to the lateral register correcting device of the present invention, the pressing members are pressure rollers in a disc shape, and the pressure rollers of the second adjusting unit have an outer diameter set larger than that of the pressure rollers of the first adjusting unit. Therefore, register is adjusted by the pressure rollers having the larger outer diameter in the outer area where the tension on the web is lower than in the central area and the fan-out can be properly corrected.

According to the lateral register correcting device of the present invention, the pressing members are pressure rollers in a disc shape, and the number of the pressure rollers per unit length in the second adjusting unit is set larger than the number of the pressure rollers per unit length in the first adjusting unit. Therefore, the register is adjusted by the plural pressure rollers having a larger number per unit length in the outer area where the tension on the web is lower than in the central area and the fan-out can be properly corrected.

According to the lateral register correcting device of the present invention, the pressing members are pressure rollers in a disc shape, and the pressure rollers in the second adjusting unit each have a roller body rotatably supported on an eccentric shaft and can change the pressure amount by changing a phase of the eccentric shaft. Therefore, the register is adjusted by the pressure rollers having larger eccentricity amounts in the outer area where the tension on the web is lower than in the central area and the fan-out can be properly corrected.

According to the lateral register correcting device of the present invention, a third adjusting unit including one pressing member arranged on an outermost side in the width direction of the web is included, and the adjusting system can adjust a pressure amount in a central area in the width direction of the web, a pressure amount in an outer area in the width direction of the web, and a pressure amount on the outermost side in the width direction of the web to different values through the first, second, and third adjusting units. Therefore, the pressure amount on the outermost side in the width direction of the web can be individually adjusted and the fan-out of the web can be properly corrected.

According to the lateral register correcting device of the present invention, the plural pressing members are located upstream in the web running direction with respect to a printing cylinder, and the pressing members in the second adjusting unit are located nearer to the printing cylinder than the pressing members in the first adjusting unit. Therefore, the register is adjusted by the pressure rollers nearer to the printing cylinder in the outer area where the tension on the web is lower than in the central area and the fan-out can be properly corrected.

According to the lateral register correcting device of the present invention, the first adjusting units are arranged at a regular interval in the central area and in the outer area on one surface side of the web, and the second adjusting unit is arranged in the outer area on the other surface side of the web. Therefore, the second adjusting unit can be located out of way of the first adjusting unit, which enables to simplify the configuration.

According to the lateral register correcting device of the present invention, the pressing members each have a pressing member body in a hollow shape having a curved surface around a central axis in the width direction of the web, and an ejection hole formed on the curved surface to jet fluid contained in the pressing member body toward the web. Therefore, the fan-out can be corrected by properly causing the web to be wavy without damaging the web.

According to the lateral register correcting device of the present invention, the adjusting system includes a control unit that can control the adjusting units, and the control unit controls the adjusting units based on web data or print data previously set. Therefore, the fan-out correction operation can be simplified.

According to the lateral register correcting device of the present invention, the adjusting system includes a control unit that can control the adjusting units and a misalignment detecting unit that detects misalignment between the web and print images, and the control unit controls the adjusting units based on a result of detection by the misalignment detecting unit. Therefore, the pressure amounts are adjusted by the adjusting units in real time, which enables to promptly correct misalignment between the web and print images.

A printing press according to the present invention includes a feeder device, a printing device, a folder, and a lateral register correcting device, and the lateral register correcting device includes a first adjusting unit that includes a plurality of pressing members arranged in a central area in the width direction of the web, a second adjusting unit that includes one or more pressing members arranged in an outer area in the width direction of the web than the first adjusting unit, and an adjusting system that can adjust a pressure amount in the central area in the width direction of the web and a pressure amount in the outer area in the width direction of the web to different values through the first and second adjusting units. Because the pressure amount in the central area and the pressure amount in the outer area to the web are accordingly adjusted to the different values by the first and second adjusting units, register adjustment amounts are appropriately adjusted to almost uniform values at all positions in the width direction of the web where the tensions are different from each other and the fan-out of the web can be properly corrected. As a result, the print quality can be improved.

According to the printing press of the present invention, the printing press includes a plate cylinder having press plates attached thereto, and a blanket cylinder facing in contact with the plate cylinder to transfer ink on the plate cylinder to the web, and the plate cylinder is an integrated plate cylinder to which a plurality of press plates can be attached on an outer peripheral surface thereof along an axial direction and that can adjust positions of the press plates with respect to the web by being axially moved with respect to a frame. Therefore, adjustment of the register in the width direction, which is not corrected by the integrated plate cylinder, can be easily performed by provision of the first and second adjusting units and independent adjustment of the pressure amount in the outer area of the web.

### BRIEF DESCRIPTION OF DRAWINGS

FIG. 1 is a schematic configuration diagram of a lateral register correcting device according to a first embodiment of the present invention.

FIG. 2 is a schematic diagram of relevant parts of a printing unit, depicting the lateral register correcting device according to the first embodiment.

FIG. 3 is a schematic configuration diagram of a web offset press for newspaper according to the first embodiment.

FIG. 4 is a schematic diagram of a printing device according to the first embodiment.

FIG. 5 is a schematic diagram of a pressed state of a web according to the lateral register correcting device of the first embodiment.

FIG. 6 is a graph of an amount of fan-out correction performed by the lateral register correcting device according to the first embodiment.

FIG. 7 is a schematic configuration diagram of a lateral register correcting device according to a second embodiment of the present invention.

FIG. 8 is a schematic configuration diagram of a lateral register correcting device according to a third embodiment of the present invention.

FIG. 9 is a schematic configuration diagram of a lateral register correcting device according to a fourth embodiment of the present invention.

FIG. 10 is a schematic configuration diagram of a lateral register correcting device according to a fifth embodiment of the present invention.

FIG. 11 is a schematic configuration diagram of a lateral register correcting device according to a sixth embodiment of the present invention.

FIG. 12A is a schematic configuration diagram of a pressure roller of a second adjusting unit in the lateral register correcting device according to the sixth embodiment.

FIG. 12B is a schematic configuration diagram of an operation of the pressure roller of the second adjusting unit in the lateral register correcting device according to the sixth embodiment.

FIG. 13 is a schematic configuration diagram of a lateral register correcting device according to a seventh embodiment of the present invention.

FIG. 14 is a schematic configuration diagram of a lateral register correcting device according to an eighth embodiment of the present invention.

FIG. 15 is a schematic diagram of a pressing member in a lateral register correcting device according to a ninth embodiment of the present invention.

FIG. 16 is a schematic configuration diagram of a lateral register correcting device according to a tenth embodiment of the present invention.

### DESCRIPTION OF EMBODIMENTS

Exemplary embodiments of a lateral register correcting device and a printing press according to the present invention will be explained below in detail with reference to the accompanying drawings. The present invention is not limited to the embodiments.

### First Embodiment

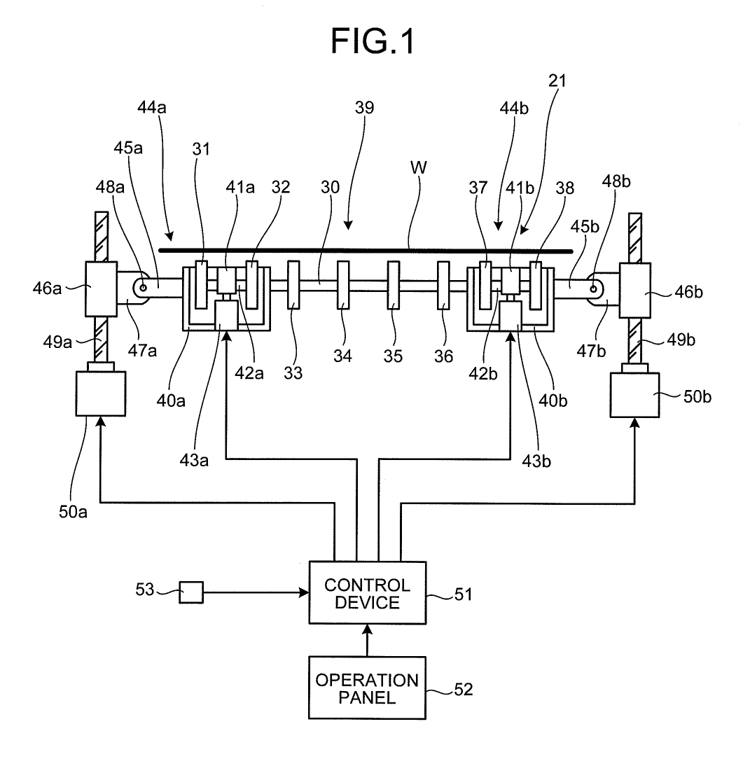

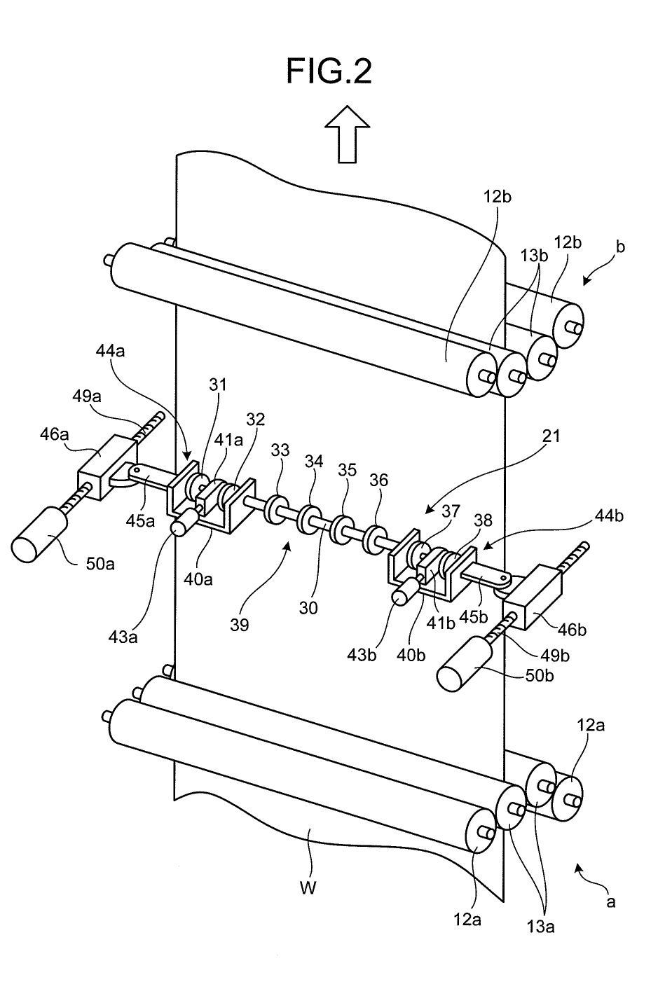

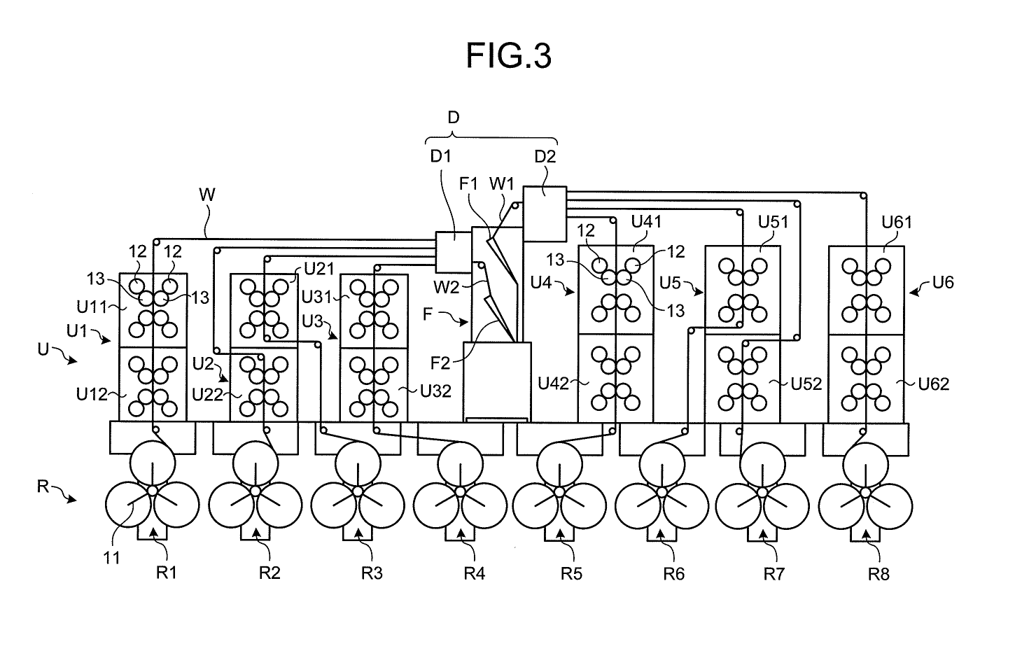

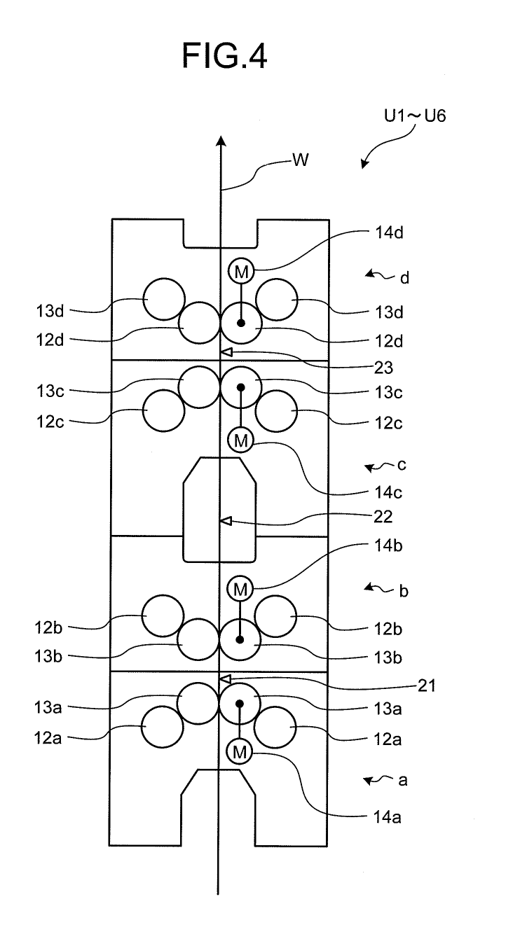

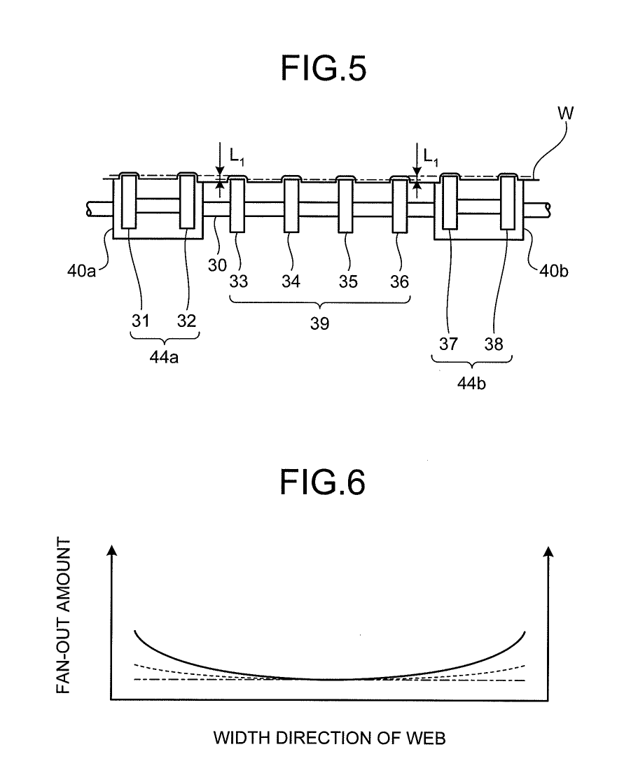

FIG. 1 is a schematic configuration diagram of a lateral register correcting device according to a first embodiment of the present invention, FIG. 2 is a schematic diagram of relevant parts of a printing unit, depicting the lateral register correcting device according to the first embodiment, FIG. 3 is a schematic configuration diagram of a web offset press for newspaper according to the first embodiment, FIG. 4 is a schematic diagram of a printing device according to the first embodiment, FIG. 5 is a schematic diagram of a pressed state of a web according to the lateral register correcting of the first embodiment, and FIG. 6 is a graph of an amount of fan-out correction performed by the lateral register correcting device according to the first embodiment.

A printing press according to the first embodiment is a web offset press for newspaper as shown in FIG. 3 and includes a feeder device R having a plurality of (eight in the present embodiment) feeder units R1 to R8, a printing device U having a plurality of (six in the present embodiment) printing units U1 to U6, a web path device D having a plurality of (two in the present embodiment) web path units D1 and D2, and a folder F having a plurality of (two in the present embodiment) folder units F1 and F2.

While this example is explained with the six printing units U1 to U6, the printing units U1 to U6 are capable of four color printing and can be vertically divided and used as 12 printing units U11, U12, U21, . . . , U61, and U62 capable of two color printing.

While the two folder units F1 and F2 are shown abreast in FIG. 3, these units are practically an operating-side folder unit F1 and a driving-side folder unit F2 arranged side by side in a direction perpendicular to the drawing sheet. While the printing device U is shown as two parts, this is just divided into two by functions and practically one device.

In the web offset press for newspaper of the present embodiment, the feeder units R1 to R8 are installed on the first floor of a building (not shown), the printing units U1 to U6 are installed on the second and third floors, the web path device D is installed on the third to fifth floors, and the folder F is installed on the second and third floors.

The feeder device R, the printing device U, the web path device D, and the folder F mentioned above are explained below in detail.

In the feeder device R, the feeder units R1 to R8 have almost the same configuration in which a holding arm 11 that holds three paper rolls, which are rolled webs W, is provided and the paper rolls can be rotated to a feeding position by rotating the holding arm 11. Each of the feeder units R1 to R8 includes a splicing device (not shown). When the rolled paper let out at the feeding position draws to an end, the splicing device can splice rolled paper at a standby position to the rolled paper at the feeding position.

In the printing device U, the printing units U1 to U6 are multicolor printing units capable of duplex four-color printing. However, the respective printing units U1 to U6 can be the printing units U11 to U62 capable of duplex two-color printing by being vertically divided. In the printing units U1 to U6, a plate cylinder 12 has a perimeter (diameter) set to be equal to a perimeter (diameter) of a blanket cylinder 13. That is, on a peripheral surface of the plate cylinder 12, it is possible to removably attach one press plate (not shown) along a circumferential direction (direction of a vertical length of the web W) and four press plates along an axial direction (width direction of the web W).

While all of the printing units U1 to U6 are multicolor printing units in the present embodiment, the present invention is not limited to this configuration. For example, various units such as a duplex two-color printing unit, a duplex monochrome printing unit, and a single-side four-color or monochrome printing unit can be appropriately combined according to prints.

In the web path device D, the web path unit D1 is provided for the printing units U1 to U3 and the web path unit D2 is provided for the printing units U4 to U6. The web path units D1 and D2 have almost the same configuration and each include a slitter that cuts the web W lengthwise (along a vertical longitudinal direction of the web W or a conveyance direction of the web W) at a central part in the width direction, a turn bar that sets a conveyance route of the web W cut lengthwise, a compensator that adjusts a conveyance position of the web W in the vertical longitudinal direction, and the like.

Therefore, in the web path unit D1, the webs W subjected to printing by the printing units U1 to U3 are cut lengthwise by the slitter, the conveyance routes thereof are changed by the turn bar, the conveyance positions thereof are adjusted by the compensator, and then the webs W are superimposed in a predetermined order. In the web path unit D2, the webs W subjected to printing by the printing units U4 to U6 are cut lengthwise by the slitter, the conveyance routes thereof are changed by the turn bar, the conveyance positions thereof are adjusted by the compensator, and then the webs W are superimposed in a predetermined order.

In the folder F, the two folder units F1 and F2 are arranged on the operating side and the driving side, respectively. Accordingly, when plural superimposed webs W1 are introduced from the web path unit D1, the folder unit F1 can fold the webs W lengthwise, cut the webs W widthwise to a predetermined length, fold the webs W widthwise to form a signature, and deliver the signature as newspaper. When plural superimposed webs W2 are introduced from the web path unit D2, the folder unit F2 can fold the webs W lengthwise, cut the webs W widthwise to a predetermined length, fold the webs W widthwise to form a signature, and deliver the signature as newspaper. In this example, in the folder F, not only the folder units F1 and F2 process the webs W1 and W2 from the corresponding web path units D1 and D2 but also one of the folder units F1 and F2 can perform the processes collectively.

In the printing device U of the web offset press for newspaper of the present embodiment, the respective printing units U1 to U6 are H-shaped tower units, thereby enabling floor-color printing, as shown in FIG. 4. In each of the printing units U1 to U6, four stacks a, b, c, and d corresponding to black, cyan, magenta, and yellow, respectively, are arranged one above another. Plate cylinders 12a, 12b, 12c, and 12d are in contact with the stacks a, b, c, and d to face each other side by side, the blanket cylinders 13a, 13b, 13c, and 13d face and are in contact with the plate cylinders 12a, 12b, 12c, and 12d, respectively, and each of the plate cylinders 12a, 12b, 12c, and 12d includes an inking system (not shown).

In this example, the plate cylinders 12a and 12c and the blanket cylinders 13a and 13c are arranged in an inverted V-shape in the stacks a and c, and the plate cylinders 12b and 12d and the blanket cylinders 13b and 13d are arranged in a V-shape in the stacks b and d, respectively.

In each of the stacks a, b, c, and d, the corresponding plate cylinders 12a, 12b, 12c, or 12d and the corresponding blanket cylinders 13a, 13b, 13c, or 13d are drive-connected with a gear (not shown) to be driven and rotated in conjunction with each other by one driving motor 14a, 14b, 14c, or 14d. That is, the plate cylinders 12a and the blanket cylinders 13a can be driven and rotated in conjunction with each other by the driving motor 14a, for example, and the other stacks b, c, and d have the same configuration.

On the outer peripheral surface of each of the plate cylinders 12a, 12b, 12c, and 12d, two (or four) press plates for printing different pictures are attached side by side in the axial direction, that is, in the width direction of the web W and printing is performed in this state. The plate cylinders 12a, 12b, 12c, and 12d are rotatably supported by frames on both sides and supported by a register device to enable axial movement (not shown). Accordingly, when the plate cylinders 12a, 12b, 12c, and 12d are axially moved by the register device, positions of the plate cylinders with respect to the web W, that is, misregistration between the web W and print images can be adjusted.

In the printing device U of the web offset press for newspaper according to the first embodiment, lateral register correcting devices 21, 22, and 23 are provided between the stacks a, b, c, and d, respectively. The lateral register correcting devices 21, 22, and 23 adjust register in the width direction of the web W based on web data or print data. The web data include the width of the web W (web size), the running speed of the web W, the tension of the web W, and the like and the print data include the coverage, and the like. In this example, the running speed and the tension of the web W can be measured online by using a sensor.

While the lateral register correcting devices 21, 22, and 23 are explained below, the lateral register correcting devices 21, 22, and 23 have almost the same configuration and thus only the lateral register correcting device 21 is explained.

In the lateral register correcting device 21, a support shaft 30 horizontal to the width direction of the web W is arranged in parallel to the web W on one surface side of the running web W, as shown in FIGS. 1 and 2. Eight pressure rollers 31 to 38 as a plurality of pressing members are provided to the support shaft 30 at a regular interval.

The four pressure rollers 33 to 36 arranged in a central area in the width direction of the web W are rotatably supported on the support shaft 30. In this example, the support shaft 30 and the four pressure rollers 33 to 36 constitutes a first adjusting unit 39. In outer areas in the width direction of the web W than the central area in the width direction of the web W, one end surfaces of cases 40a and 40b are fixed to respective axial ends of the support shaft 30. Movement members 41a and 41b are supported in the cases 40a and 40b to freely move in a direction perpendicular to the web W. The pressure rollers 31, 32, 37, and 38 are rotatably supported on the movement members 41a and 41b via support shafts 42a and 42b, respectively. The movement members 41a and 41b are enabled to reciprocate by actuators 43a and 43b. In this example, the cases 40a and 40b, the movement members 41a and 41b, the support shafts 42a and 42b, and the pressure rollers 31, 32, 37, and 38 constitute second adjusting units 44a and 44b, which are arranged in the outer areas in the width direction of the web W than the first adjusting unit 39.

One ends of attachment levers 45a and 45b are fixed to the other end surfaces of the cases 40a and 40b, and attachment units 47a and 47b of movement blocks 46a and 46b are connected to the other ends of the attachment levers 45a and 45b with connection shafts 48a and 48b to enable horizontal pivoting. On sides in the width direction of the running web W, threaded shafts 49a and 49b are arranged in a direction horizontal and perpendicular to the web W and enabled to rotate by driving motors 50a and 50b. The threaded shafts 49a and 49b are screwed into the movement blocks 46a and 46b, respectively.

Accordingly, when the threaded shafts 49a and 49b are rotated in a positive rotation direction by the driving motors 50a and 50b, the movement blocks 46a and 46b move forward (upward in FIG. 1) so that the eight pressures rollers 31 to 38 can be moved in a direction toward the web W via the cases 40a and 40b, the support shaft 30, and the like. On the other hand, when the threaded shafts 49a and 49b are rotated in a negative rotation direction by the driving motors 50a and 50b, the movement blocks 46a and 46b move backward (downward in FIG. 1) so that the eight pressure rollers 31 to 38 can be moved in a direction away from the web W via the cases 40a and 40b, the support shaft 30, and the like.

The actuators 43a and 43b enable the four pressure rollers 31, 32, 37, and 38 to move in the direction toward the web W or in the direction away from the web W via the movement members 41a and 41b, and the like.

When the eight pressure rollers 31 to 38 are moved in the direction toward the web W to press the running web W from one surface, parts of the web W pressed by the pressure rollers 31 to 38 project on the other surface, which causes the web W to be wavy. Although the web W is extended widthwise due to ink and dampening water supplied during printing, the length in the width direction is reduced because of the wavy form produced by the pressure rollers 31 to 38 and can be modified to one before the printing, that is, fan-out can be corrected. As a result, misregistration between the web W and the print images can be adjusted.

In this example, when fan-out amounts are different between one side and the other side of the web W in the width direction, movement amounts of the movement blocks 46a and 46b by the driving motors 50a and 50b or driving amounts of the actuators 43a and 43b are made different to bring the pressure rollers 31 to 38 closer to the web W so that the support shaft 30 inclines with respect to the web W. By doing so, such fan-out can be handled.

In the present embodiment, the threaded shafts 49a and 49b, the driving motors 50a and 50b, and the like constitute a first driving device that can drive the first adjusting unit 39 and the second adjusting units 44a and 44b together. The actuators 43a and 43b and the like constitute a second driving device that can drive only the second adjusting units 44a and 44b. These driving devices constitute an adjusting system according to the present invention.

While predetermined tensions act on the web W when the web W passes through the printing units, the tensions on the web W are higher at the central part in the width direction and lower at outer sides thereof, that is, at the side parts of the web W. Accordingly, even when the web W is caused to be wavy by moving forward the pressure rollers 31 to 38 by the same amount with respect to the web W having the fan-out occurred, it is difficult to form sufficient waves on the side parts as compared to the central part, which prevents the fan-out of the web W from being properly corrected.

Therefore, the lateral register correcting device 21 of the present embodiment enables to adjust the pressure amounts in the central area in the width direction of the web W and the pressure amounts in the outer areas in the width direction of the web W to different values by using the first adjusting unit 39 and the second adjusting units 44a and 44b. Specifically, the pressure amounts in the outer areas in the width direction of the web W are adjusted to be larger than those in the central area in the width direction of the web W.

That is, a control device 51 can drive-control the driving motors 50a and 50b as the first driving device and can drive-control the actuators 43a and 43b as the second driving device. An operation panel 52 is connected to the control device 51 and, when an operator inputs a command value through the operation panel 52, the control device 51 drive-controls the driving motors 50a and 50b and the actuators 43a and 43b based on the input command value.

The control device 51 first causes the driving motors 50a and 50b to rotate the threaded shaft 49a and 49b in the positive rotation direction to move the movement blocks 46a and 46b forward and move all the pressures rollers 31 to 38 in the direction toward the web W via the support shaft 30, thereby pressing the web W with the pressure rollers 31 to 38 to cause the web W to be wavy. The web W then has the entire area in the width direction made wavy and the length in the width direction is reduced. However, because the tensions in the outer areas in the width direction are lower, the forms of the waves in these areas are smaller.

The control device 51 then causes the actuators 43a and 43b to move only the four pressure rollers 31, 32, 37, and 38 in the direction toward the web W, thereby pressing only the outer areas of the web W with the pressure rollers 31, 32, 37, and 38 to cause the outer areas to be wavy. In this way, although tensions are lower in the outer areas of the web W in the width direction, the pressure amounts (projection amounts) of the pressure rollers 31, 32, 37, and 38 become larger than the pressure amounts (projection amounts) of the pressure rollers 33 to 36 in the central area by a length L₁, as shown in FIG. 5. Accordingly, the web W becomes an almost uniformly wavy form in the width direction and the length in the width direction is reduced to appropriate one. As a result, the web W has a length in the width direction modified to the length before the printing, so that the fan-out can be properly corrected.

Although it is explained that the first adjusting unit 39 and the second adjusting units 44a and 44b separately operate, the first and second adjusting units practically operate at the same time. The control device 51 previously calculates forward movement amounts of the pressure rollers 31 to 38 produced by the adjusting units 39, 44a, and 44b based on the input command value, the web data, the print data, and the like and, upon start of printing, causes the lateral register correcting device 21 to automatically operate (preset control).

In each of the printing units U1 to U6, a plurality of cameras 53 serving as a misalignment detecting unit that detects misalignment between the web W and print images are provided downstream in the conveyance direction of the web W in the four stacks a, b, c, and d. Images taken by the cameras 53 are transmitted to the control device 51, and the control device 51 adjusts the pressure amounts of the pressure rollers 31 to 38 produced by the first adjusting unit 39 and the second adjusting units 44a and 44b based on the images taken by the cameras 53. In this example, a plurality of register marks are printed on the web W at predetermined positions in the width direction and the cameras 53 take images of the register marks. The control device 51 determines whether the register marks taken by the cameras 53 are at predetermined reference positions in the width direction. When the register marks are not at the reference positions, the control device 51 feedback-controls the first adjusting unit 39 and the second adjusting units 44a and 44b to locate the register marks at the reference positions. In this way, by adjusting the pressure amounts produced by the adjusting units 33, 44a, and 44b in real time, the misalignment between the web W and the print images can be promptly corrected.

FIG. 6 is a graph of a fan-out amount of the web W and corrected amounts thereof. When the fan-out amount of the web W subjected to printing is as shown by a solid line in FIG. 6 and when the pressure amounts (projection amounts) of the pressure rollers 31 to 38 are set equal like in the conventional technique, the tensions on the web W in the outer areas in the width direction are lower, which prevents the fan-out from being sufficiently corrected in the outer areas as shown by a dotted line in FIG. 6. On the other hand, when the pressure amounts (projection amounts) of the pressure rollers 31, 32, 37, and 38 in the outer areas are set larger than the pressure amounts (projection amounts) of the pressure rollers 33 to 36 in the central area like in the present embodiment, the fan-out can be sufficiently corrected in all the areas as shown by a dashed-dotted line in FIG. 6 although the tensions on the web W in the outer areas in the width direction are lower.

As described above, the lateral register correcting device according to the first embodiment is configured to adjust the register in the width direction of the web W by pressing the pressure rollers 31 to 38 arranged along the width direction of the web W from one surface of the running web W to cause the web W to be wavy. The lateral register correcting device includes the first adjusting unit 39 including the four pressure rollers 33 to 36 arranged in the central area in the width direction of the web W and the second adjusting units 44a and 44b including the four pressure rollers 31, 32, 37, and 38 arranged in the outer areas in the width direction of the web W than the first adjusting unit 39. Accordingly, the lateral register correcting device according to the first embodiment can adjust the pressure amounts in the central area in the width direction of the web W and the pressure amounts in the outer areas in the width direction of the web W to different values by using the first adjusting unit 39 and the second adjusting units 44a and 44b (the adjusting system).

Because the pressure amounts in the central area and the pressure amounts in the outer areas to the web W can be adjusted to the different values by the first adjusting unit 39 and the second adjusting units 44a and 44b, the register adjustment amounts can be appropriately adjusted to almost uniform values at all positions in the width direction of the web W where the tensions are different from each other, and the fan-out of the web W can be properly corrected, resulting in an improved print quality.

In the lateral register correcting device according to the first embodiment, the pressure amounts in the outer areas in the width direction of the web W are adjusted to be larger than the pressure amounts in the central area in the width direction of the web W. Accordingly, the register adjustment amounts become almost uniform in all the areas in the width direction of the web W by setting the pressure amounts in the outer areas of the web W where the tensions are lower to larger values than in the central area, and the fan-out can be properly corrected in all the areas of the web W.

The lateral register correcting device according to the first embodiment has the driving motors (the first driving devices) 50a and 50b that can drive the first adjusting unit 39 and the second adjusting units 44a and 44b together, and the actuators (the second driving device) 43a and 43b that can drive only the second adjusting units 44a and 44b as the adjusting system. Therefore, the pressure amounts are uniformly adjusted in all the areas in the width direction of the web W through integral driving of the first adjusting unit 39 and the second adjusting units 44a and 44b by the driving motors 50a and 50b, and the pressure amounts in the outer areas in the width direction of the web W are individually adjusted through driving of only the second adjusting units 44a and 44b by the actuators 43a and 43b. Accordingly, the fan-out of the web W can be properly corrected and the operation to correct the fan-out can be easily performed in a short time.

In the web offset press according to the first embodiment, the plate cylinders 12a, 12b, 12c, and 12d are integrated plate cylinders having the outer peripheral surfaces on which plural press plates can be attached in the axial direction and having the positions of the press plates with respect to the web W adjustable by moving the plate cylinders in the axial direction with respect to the frames. Therefore, the pressure amounts in the outer areas of the web W can be independently adjusted by the first adjusting unit 39 and the second adjusting units 44a and 44b, thereby easily adjusting the register in the width direction that has not been corrected by the integrated plate cylinders. That is, in the integrated plate cylinders, while the plural press plates are attached along the axial direction on the peripheral surface of each of the plate cylinders 12, position adjustment in the width direction (the axial direction of the plate cylinders) between the press plates cannot be performed. However, in the present embodiment, the position adjustment in the width direction between the press plates can be performed by correcting the fan-out with the first adjusting unit 39 and the second adjusting units 44a and 44b.

### Second Embodiment

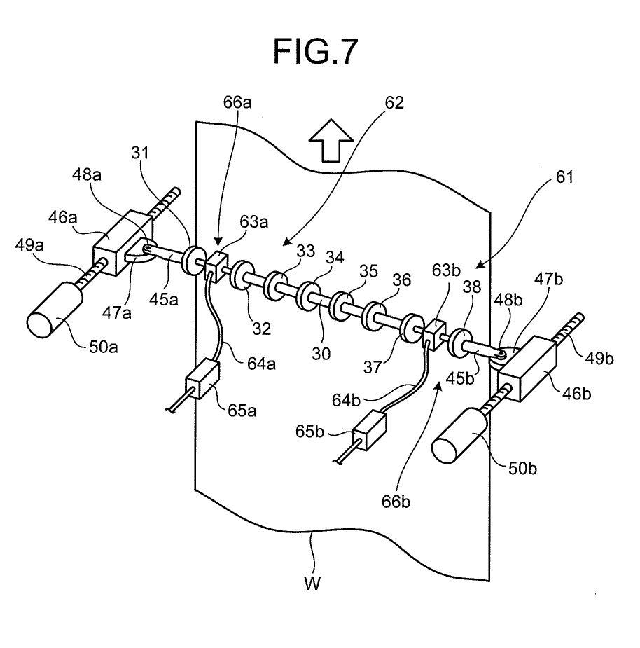

FIG. 7 is a schematic configuration diagram of a lateral register correcting device according to a second embodiment of the present invention. Elements having functions identical to those of the embodiment described above are denoted by like reference signs and redundant explanations thereof will be omitted.

In the second embodiment, a lateral register correcting device 61 is provided on one surface side of the running web W as shown in FIG. 7. In the lateral register correcting device 61, the support axis 30 horizontal to the width direction of the web W is arranged in parallel to the web W, and the eight pressure rollers 31 to 38 arranged at the regular interval in the entire area (the central area and the outer areas) in the width direction of the web W are rotatably supported on the support shaft 30. In this example, the support shaft 30 and the eight pressure rollers 31 to 38 constitute a first adjusting unit 62.

Air nozzles 63a and 63b are attached to the support shaft 30 in the outer areas in the width direction of the web W than the central area in the width direction of the web W between the pressure rollers 31 and 32 and between the pressure rollers 37 and 38, respectively. An air supply source (not shown) is connected to the air nozzles 63a and 63b via air pipes 64a and 64b and pressure reducing valves 65a and 65b, respectively. In this example, the air nozzles 63a and 63b, the air pipes 64a and 64b, and the air supply source constitute second adjusting units 66a and 66b.

One ends of the attachment levers 45a and 45b are fixed to the respective ends of the support shaft 30, and the attachment units 47a and 47b of the movement blocks 46a and 46b are connected to the other ends of the attachment levers 45a and 45b via the connection shafts 48a and 48b to horizontally pivot. The threaded shafts 49a and 49b are arranged on the sides in the width direction of the running web W and enabled to rotate by means of the driving motors 50a and 50b. The threaded shafts 49a and 49b are screwed into the movement blocks 46a and 46b, respectively.

Accordingly, when the threaded shafts 49a and 49b are rotated in the positive rotation direction by the driving motors 50a and 50b, the movement blocks 46a and 46b move forward and thus the eight pressure rollers 31 to 38 can be moved in the direction toward the web W via the support shaft 30. Air in the air supply source is delivered to the air nozzles 63a and 63b through the air pipes 64a and 64b, and the air can be jetted toward the web W through the air nozzles 63a and 63b.

When the eight pressure rollers 31 to 38 are moved in the direction toward the web W and press the running web W from one surface, parts of the web W pressed by the pressure rollers 31 to 38 project on the other surface side, thereby causing the web W to be wavy. Although the web W is extended widthwise due to the ink and the dampening water supplied during printing, the web W is made wavy by the pressure rollers 31 to 38, and the length in the width direction is reduced and can be modified to one before the printing. That is, the fan-out can be corrected and consequently misregistration between the web W and the print images can be adjusted.

In the present embodiment, the threaded shafts 49a and 49b, the driving motors 50a and 50b, and the like constitute a first driving device that can drive the first adjusting unit 62 and the second adjusting units 66a and 66b together. The air nozzles 63a and 63b, the pressure reducing valves 65a and 65b, and the like constitute a second driving device that can drive only the second adjusting units 66a and 66b. These driving devices constitute the adjusting system according to the present invention.

In the lateral register correcting device 61 of the present embodiment, the pressure amounts in the central area in the width direction of the web W and the pressure amounts in the outer areas in the width direction of the web W can be adjusted to different values by the first adjusting unit 62 and the second adjusting units 66a and 66b. Specifically, the pressure amounts in the outer areas in the width direction of the web W are adjusted to be larger than those in the central area in the width direction of the web W.

That is, the control device (not shown) can drive-control the driving motors 50a and 50b functioning as the first driving device and also can drive-control the pressure reducing valves 65a and 65b functioning as the second driving device. Accordingly, the control device causes the driving motors 50a and 50b to rotate the threaded shafts 49a and 49b in the positive rotation direction to move the movement blocks 46a and 46b forward and move all the pressure rollers 31 to 38 in the direction toward the web W via the support shaft 30, thereby pressing the web W with the pressure rollers 31 to 38 to cause the web W to be wavy. Although the length in the width direction of the web W is reduced because all the areas in the width direction become wavy, the waves in the outer areas are smaller due to the lower tensions in the outer areas in the width direction.

Therefore, the control device causes the pressure reducing valves 65a and 65b to jet air toward the web W out of the air nozzles 63a and 63b, thereby pressing only the outer areas of the web W with the jetted air to form waves in these areas. Although the tensions in the outer areas of the web W in the width direction are lower, the pressure amounts (projection amounts) of the pressure rollers 31, 32, 37, and 38 and the jetted air from the air nozzles 63a and 63b become larger than the pressure amounts (projection amounts) of the pressure rollers 33 to 36 in the central area. Accordingly, the web W becomes almost uniformly wavy in the width direction and has the length in the width direction reduced to appropriate one. As a result, the web W has the length in the width direction modified to one before the printing and the fan-out can be properly corrected.

As described above, the lateral register correcting device according to the second embodiment includes the first adjusting unit 62 including the eight pressure rollers 31 to 38 arranged in the entire area in the width direction of the web W and the second adjusting units 66a and 66b including the two air nozzles 63a and 63b arranged in the outer areas in the width direction of the web W, and can adjust the pressure amounts in the central area in the width direction of the web W and the pressure amounts in the outer areas in the width direction of the web W to different values by using the first adjusting unit 62 and the second adjusting units 66a and 66b (the adjusting system).

Because the pressure amounts in the central area and the pressure amounts in the outer areas to the web W are adjusted to the different values by the first adjusting unit 62 and the second adjusting units 66a and 66b, the register adjustment values are appropriately adjusted to almost uniform values at all positions in the width direction of the web W where the tensions are different from each other, and the fan-out of the web W can be properly corrected. As a result, the print quality can be improved.

The lateral register correcting device according to the second embodiment adjusts the pressure amounts in the outer areas in the width direction of the web W to be larger than the pressure amounts in the central area in the width direction of the web W. Therefore, due to the pressure amounts set larger in the outer areas of the web W where the tensions are lower than those in the central area, the register adjustment values become almost uniform in all the areas in the width direction of the web W and the fan-out can be properly corrected in the entire area of the web W.

Furthermore, the lateral register correcting device according to the second embodiment has the air nozzles 63a and 63b as the second adjusting units 66a and 66b. Therefore, there is no need to change the first adjusting unit 62 including the eight pressure rollers 31 to 38 and it suffices to add only the two air nozzles 63a and 63b, which prevents complication in the configuration or increase in the costs.

### Third Embodiment

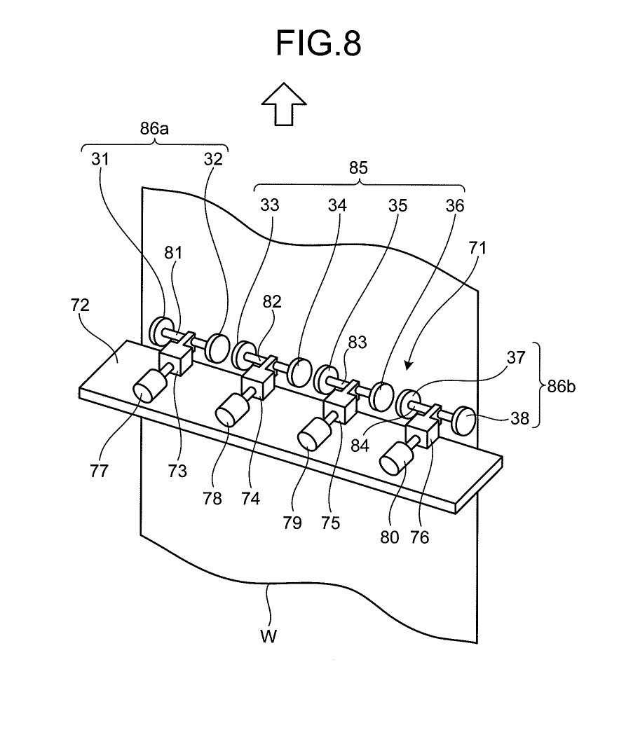

FIG. 8 is a schematic configuration diagram of a lateral register correcting device according to a third embodiment of the present invention. Elements having functions identical to those of the embodiments described above are denoted by like reference signs and redundant explanations thereof will be omitted.

In the third embodiment, a lateral register correcting device 71 is provided on one surface side of the running web W as shown in FIG. 8. In the lateral register correcting device 71, four movement members 73, 74, 75, and 76 are arranged on a support frame 72 in the width direction of the web W, and the movement members 73, 74, 75, and 76 are supported by actuators 77, 78, 79, and 80 to move in a direction perpendicular to the web W, respectively. Support shafts 81, 82, 83, and 84 horizontal to the width direction of the web W are attached to the movement members 73, 74, 75, and 76 in parallel to the web W, respectively. The eight pressure rollers 31 to 38 arranged at the regular interval in the entire area (the central area and the outer areas) in the width direction of the web W are rotatably supported on the support shafts 81, 82, 83, and 84.

In this example, the support shafts 82 and 83 and the four pressure rollers 33 to 36 constitute a first adjusting unit 85. The support shafts 81 and 84 and the four pressure rollers 31, 32, 37, and 38 constitute second adjusting units 86a and 86b.

Therefore, when the movement members 73, 74, 75, and 76 are moved forward by the actuators 77, 78, 79, and 80, the eight pressure rollers 31 to 38 can be moved in the direction toward the web W via the support shafts 81, 82, 83, and 84. When the eight pressure rollers 31 to 38 are pressed on the running web W from one surface, parts of the web W pressed by the pressure rollers 31 to 38 project on the other surface side and the web W becomes wavy. Although the web W is extended widthwise due to the ink and the dampening water supplied during printing, the length in the width direction is reduced because of the wavy form produced by the pressure rollers 31 to 38 and can be modified to the one before the printing. That is, the fan-out can be corrected and consequently misregistration between the web W and print images can be adjusted.

In the present embodiment, the actuators 78 and 79 and the like constitute a first driving device that can independently drive the first adjusting unit 85, and the actuators 77 and 80 and the like constitute a second driving device that can independently drive the second adjusting units 86a and 86b. These driving devices constitute the driving system according to the present invention.

The lateral register correcting device 71 of the present embodiment can adjust the pressure amounts in the central area in the width direction of the web W and the pressure amounts in the outer areas in the width direction of the web W to different values by using the first adjusting unit 85 and the second adjusting units 86a an 86b. Specifically, the lateral register correcting device 71 adjusts the pressure amounts in the outer areas in the width direction of the web W to be larger than those in the central area in the width direction of the web W.

That is, the control device (not shown) can drive-control the actuators 78 and 79 as the first driving device and also can drive-control the actuators 77 and 80 as the second driving device. Therefore, the control device moves the pressure rollers 31 to 38 in the direction toward the web W through the actuators 77, 78, 79, and 80 to press the web W with the pressure rollers 31 to 38, thereby causing the web W to be wavy. While the web W is reduced in length in the width direction due to the wavy form in the entire area in the width direction, the web W has smaller waves in the outer areas in the width direction because the tensions in the outer areas are lower.

Accordingly, the control device moves the pressure rollers 31, 32, 37, and 38 in the direction toward the web W through the actuators 77 and 80, thereby pressing only the outer areas of the web W with the pressure rollers 31 to 38 to cause the outer areas to be wavy. While the tensions are lower in the outer areas in the width direction, the web W becomes almost uniformly wavy in the width direction and has a length in the width direction reduced to appropriate one because the pressure amounts (projection amounts) of the pressure rollers 31, 32, 37, and 38 become larger than the pressure amounts (projection amounts) of the pressure rollers 33 to 36 in the central area. As a result, the length in the width direction of the web W is modified to the one before the printing and the fan-out can be properly corrected.

As described above, the lateral register correcting device according to the third embodiment includes the first adjusting unit 85 including the four pressure rollers 33 to 36 arranged in the central area in the width direction of the web W, and the second adjusting units 86a and 86b including the four pressure rollers 31, 32, 37, and 38 arranged in the outer areas in the width direction of the web W. The lateral register correcting device according to the third embodiment adjusts the pressure amounts in the central area in the width direction of the web W and the pressure amounts in the outer areas in the width direction of the web W to different values, that is, adjusts the pressure amounts in the outer areas in the width direction of the web W to be larger than those in the central area in the width direction of the web W by using the first adjusting unit 85 and the second adjusting units 86a and 86b.

Therefore, due to the pressure amounts in the outer areas of the web W where the tensions are lower, set larger than those in the central area, the register adjustment amounts are appropriately adjusted to almost uniform values at all positions in the width direction of the web W where the tensions are different from each other and the fan-out of the web W can be properly corrected. As a result, the print quality can be improved.

Furthermore, the lateral register correcting device according to the third embodiment includes the actuators 77, 78, 79, and 80 that can drive the first adjusting unit 85 and the second adjusting units 86a and 86b independently. Therefore, by the actuators 77, 78, 79, and 80 that drive the adjusting units 85, 86a, and 86b independently, the register adjustment in the central area and the outer areas in the width direction of the web W can be performed separately to properly correct the fan-out in the entire area and to easily perform the fan-out correction operation in a short time.

### Fourth Embodiment

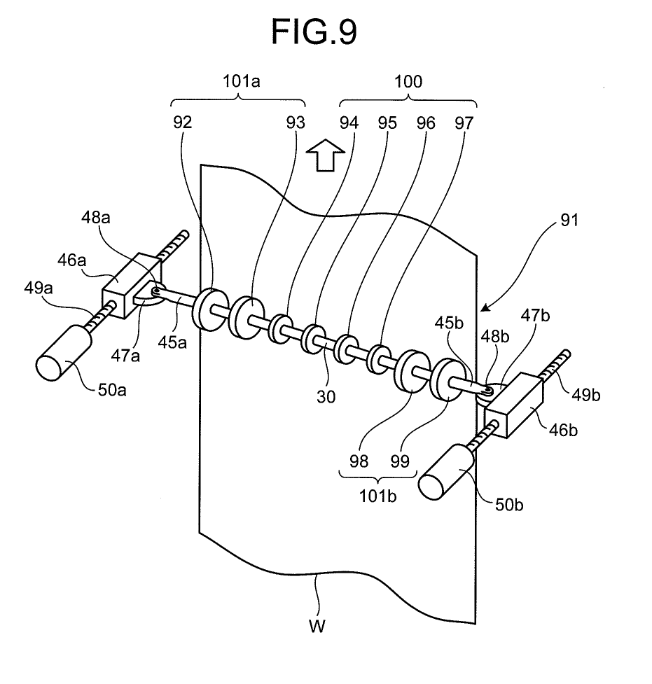

FIG. 9 is a schematic configuration diagram of a lateral register correcting device according to a fourth embodiment of the present invention. Elements having functions identical to those of the embodiments described above are denoted by like reference signs and redundant explanations thereof will be omitted.

In the fourth embodiment, a lateral register correcting device 91 is provided on one surface side of the running web W as shown in FIG. 9. In the lateral register correcting device 91, the support shaft 30 horizontal to the width direction of the web W is arranged in parallel to the web W and eight pressure rollers 92 to 99 arranged in the entire area (the central area and the outer areas) in the width direction of the web W at a regular interval are rotatably support on the support shaft 30.

In this example, the four pressure rollers 92, 93, 98, and 99 arranged in the outer areas have an outer diameter set larger than that of the four pressure rollers 94 to 97 arranged in the central area in the width direction of the web W. The support shaft 30 and the four pressure rollers 94 to 97 constitute a first adjusting unit 100, and the support shaft 30 and the four pressure rollers 92, 93, 98, and 99 constitute second adjusting units 101a and 101b.

Accordingly, when the threaded shafts 49a and 49b are rotated in the positive rotation direction by the driving motors 50a and 50b, the movement blocks 46a and 46b move forward, which enables to move the eight pressure rollers 92 to 99 in the direction toward the web W via the support shaft 30. When the eight pressure rollers 92 to 99 are moved to the direction toward the web W to press the running web W from one surface, parts of the web W pressed by the pressure rollers 92 to 99 project on the other surface side and then the web W becomes wavy. Although the web W is extended widthwise due to the ink and the dampening water supplied during printing, the length in the width direction is reduced because of the wavy form produced by the pressure rollers 92 to 99 and can be modified to the one before the printing, that is, the fan-out can be corrected. As a result, misregistration between the web W and the print images can be adjusted.

The lateral register correcting device 91 of the present embodiment can adjust the pressure amounts in the central area in the width direction of the web W and the pressure amounts in the outer areas in the width direction of the web W to different values through the first adjusting unit 100 and the second adjusting units 101a and 101b. Specifically, the pressure amounts in the outer areas in the width direction of the web W are adjusted to be larger than those in the central area in the width direction of the web W.

That is, the pressure rollers 92, 93, 98, and 99 in the second adjusting units 101a and 101b have an outer diameter set larger than that of the pressure rollers 94 to 97 in the first adjusting unit 100. Accordingly, the control device rotates the threaded shafts 49a and 49b in the positive rotation direction through the driving motors 50a and 50b to move the movement blocks 46a and 46b forward and move all the pressure rollers 92 to 99 in the direction toward the web W via the support shaft 30, thereby pressing the web W with the pressure rollers 92 to 99 to cause the web W to be wavy. At that time, because the outer diameter of the pressure rollers 92, 93, 98, and 99 in the outer areas is larger, the pressure amounts (projection amounts) of the pressure rollers 92, 93, 98, and 99 become larger than the pressure amounts (projection amounts) of the pressure rollers 94 to 97 in the central area. Although the tensions are lower in the outer areas in the width direction, the web W becomes almost uniformly wavy in the width direction and the length in the width direction is reduced to appropriate one. As a result, the web W has a length in the width direction modified to the one before the printing and the fan-out can be properly corrected.

As described above, the lateral register correcting device according to the fourth embodiment includes the first adjusting unit 100 including the four pressure rollers 94 to 97 arranged in the central area in the width direction of the web W, and the second adjusting units 101a and 101b including the four pressure rollers 92, 93, 98, and 99 arranged in the outer areas in the width direction of the web W, in which the outer diameter of the pressure rollers 92, 93, 98, and 99 in the second adjusting units 101a and 101b is set larger than that of the pressure rollers 94 to 97 in the first adjusting unit 100.

Therefore, the pressure amounts (projection amounts) to the web W of the pressure rollers 92, 93, 98, and 99 of the second adjusting units 101a and 101b in the outer areas become larger than the pressure amounts (projection amounts) of the pressure rollers 94 to 97 of the first adjusting unit 100 in the central area, which enables to appropriately adjust the register adjustment amounts to almost uniform values at all positions in the width direction of the web W where the tensions are different from each other and to properly correct the fan-out of the web W. As a result, the print quality can be improved.

### Fifth Embodiment

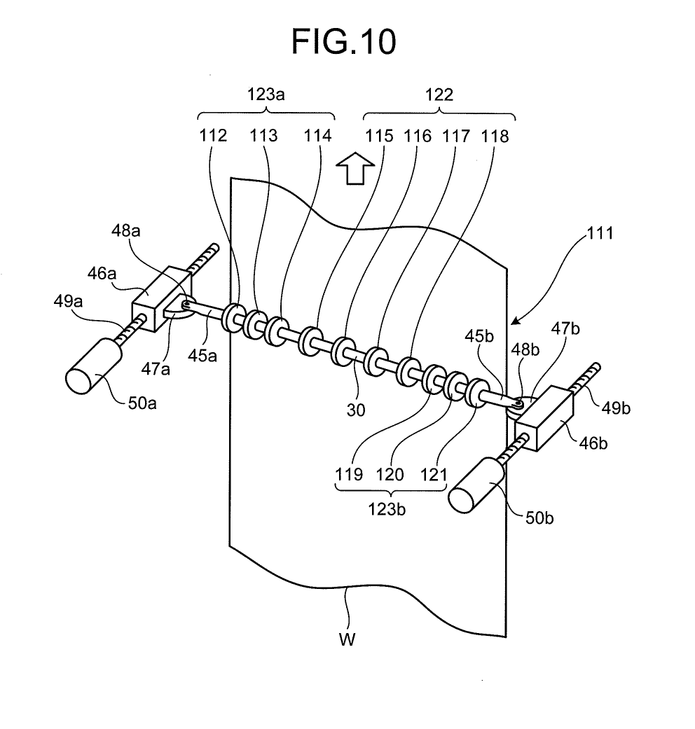

FIG. 10 is a schematic configuration diagram of a lateral register correcting device according to a fifth embodiment of the present invention. Elements having functions identical to those of the embodiments described above are denoted by like reference signs and redundant explanations thereof will be omitted.

In the fifth embodiment, a lateral register correcting device 111 is provided on one surface side of the running web W as shown in FIG. 10. In the lateral register correcting device 111, the support shaft 30 horizontal to the width direction of the web W is arranged in parallel to the web W and ten pressure rollers 112 to 121 arranged at regular intervals in the entire area (the central area and the outer areas) in the width direction of the web W are rotatably supported on the support shaft 30.

In this example, while all the pressure rollers 112 to 121 have the same outer diameter, the number per predetermined unit length of the six pressure rollers 112 to 114 and 119 to 121 arranged in the outer areas is set larger than the number per predetermined unit length of the four pressure rollers 115 to 118 arranged in the central area in the width direction of the web W. Specifically, the distance between the six pressure rollers 112 to 114 and 119 to 121 arranged in the outer areas is smaller than that between the four pressure rollers 115 to 118 arranged in the central area. The support shaft 30 and the four pressure rollers 115 to 118 constitute a first adjusting unit 122, and the support shaft 30 and the six pressure rollers 112 to 114 and 119 to 121 constitute second adjusting units 123a and 123b.

Accordingly, when the threaded shafts 49a and 49b are rotated in the positive rotation direction by the driving motors 50a and 50b, the movement blocks 46a and 46b move forward, which enables to move the ten pressure rollers 112 to 121 in the direction toward the web W via the support shaft 30. When the ten pressure rollers 112 to 121 are moved in the direction toward the web W to press the running web W from one surface, parts of the web W pressed by the pressure rollers 112 to 121 project on the other surface side, which causes the web W to be wavy. Although the web W is extended widthwise due to the ink and the dampening water supplied during printing, the length in the width direction is reduced because of the wavy form produced by the pressure rollers 112 to 121 and can be modified to the one before the printing. That is, the fan-out can be corrected and consequently the misregistration between the web and the print images can be adjusted.

The lateral register correcting device 111 of the present embodiment can adjust the pressure amounts in the central area in the width direction of the web W and the pressure amounts in the outer areas in the width direction of the web W to different values through the first adjusting unit 122 and the second adjusting units 123a and 123b. Specifically, the pressure amounts in the outer areas in the width direction of the web W are adjusted to be larger than those in the central area in the width direction of the web W.

That is, the number per unit length of the pressure rollers 112 to 114 and 119 to 121 in the second adjusting units 123a and 123b is set larger than that of the pressure rollers 115 to 118 in the first adjusting unit 122. Therefore, the control device causes the driving motors 50a and 50b to rotate the threaded shafts 49a and 49b in the positive rotation direction to move the movement blocks 46a and 46b forward and move all the pressure rollers 112 to 121 in the direction toward the web W via the support shaft 30, thereby pressing the web W with the pressure rollers 112 to 121 to cause the web W to be wavy. At that time, because the number of per unit length of the pressure rollers 112 to 114 and 119 to 121 in the outer areas is larger, the pressure amount (projection amount) per unit length of the pressure rollers 112 to 114 and 119 to 121 becomes larger than the pressure amount (projection amount) per unit length of the pressure rollers 114 to 118 in the central area. Accordingly, although the tensions are lower in the outer areas in the width direction, the web W becomes almost uniformly wavy in the width direction and the length in the width direction is reduced to appropriate one. As a result, the length in the width direction of the web W is modified to the one before the printing and the fan-out can be properly corrected.

As described above, the lateral register correcting device according to the fifth embodiment includes the first adjusting unit 122 including the four pressure rollers 115 to 118 arranged in the central area in the width direction of the web W, and the second adjusting units 123a and 123b including the four pressure rollers 112 to 114 and 119 to 121 arranged in the outer areas in the width direction of the web W, in which the number per unit length of the pressure rollers 112 to 114 and 119 to 121 in the second adjusting units 123a and 123b is set larger than that of the pressure rollers 115 to 118 in the first adjusting unit 122.

Therefore, the pressure amount (projection amount) per unit length to the web W of the pressure rollers 112 to 114 and 119 to 121 in the second adjusting units 123a and 123b in the outer areas is larger than the pressure amount (projection amount) per unit length of the pressure rollers 115 to 118 in the first adjusting unit 122 in the central area. This enables to appropriately adjust the register adjustment amounts to almost uniform values at all positions in the width direction of the web W where the tensions are different from each other and to properly correct the fan-out of the web W, and consequently improves the print quality.

### Sixth Embodiment

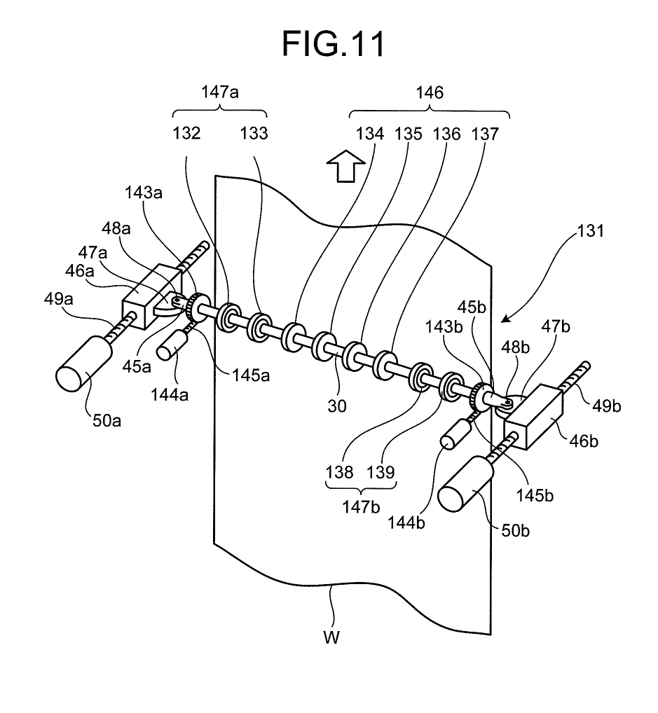

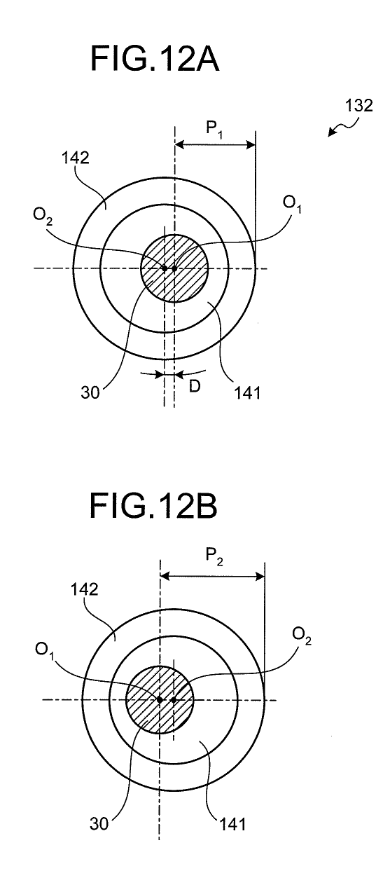

FIG. 11 is a schematic configuration diagram of a lateral register correcting device according to a sixth embodiment of the present invention, FIG. 12A is a schematic configuration diagram of a pressure roller of a second adjusting unit in the lateral register correcting device according to the sixth embodiment, and FIG. 12B is a schematic configuration diagram of an operation of the pressure roller of the second adjusting unit in the lateral register correcting device according to the sixth embodiment. Elements having functions identical to those of the embodiments described above are denoted by like reference signs and redundant explanations thereof will be omitted.

In the sixth embodiment, a lateral register correcting device 131 is provided on one surface side of the running web W as shown in FIG. 11. In the lateral register correcting device 131, the support shaft 30 horizontal to the width direction of the web W is arranged in parallel to the web W and eight pressure rollers 132 to 139 arranged at a regular interval in the entire area (the central area and the outer areas) in the width direction of the web W are rotatably supported on the support shaft 30.

In this example, the four pressure rollers 132, 133, 138, and 139 arranged in the outer areas in the width direction of the web W are capable of decentering and can change the pressure amounts by changing the phases. Because the pressure rollers 132, 133, 138, and 139 have the same configuration, only the pressure roller 132 is explained below in detail. That is, in the pressure roller 132 as shown in FIG. 12A, an eccentric shaft 141 having a rotation center O₂ is attached to the support shaft 30 having a rotation center O₁ to enable relative rotation, and a roller body 142 having the rotation center O₂ is rotatably supported on the eccentric shaft 141. In this example, a predetermined eccentricity amount D is set between the rotation center O₁ and the rotation center O₂.

As shown in FIG. 11, worm wheels 143a and 143b are firmly coupled to ends of the support shaft 30, and worm gears 145a and 145b of adjustment motors 144a and 144b engage with the worm wheels 143a and 143b, respectively. In this example, the ends of the support shaft 30 are connected to one ends of attachment levers 45a and 45b through rotary joint (not shown) to enable rotation, so that the support shaft 30 can rotate with respect to the attachment levers 45a and 45b.

Accordingly, a pressure distance P₁ from the rotation center O₁ of the support shaft 30 to the outer peripheral surface of the roller body 142 pressing the web W is set in a state shown in FIG. 12A. On the other hand, when the adjustment motors 144a and 144b are driven to rotate the support shaft by 180 degrees via the worm gears 145a and 145b and the worm wheels 143a and 143b as shown in FIG. 11, the phase of the eccentric shaft 141 is changed so that a pressure distance P₂ from the rotation center O₁ of the support shaft 30 to the outer peripheral surface of the roller body 142 pressing the web W is set larger as shown in FIG. 12B. In this way, the pressure amount on the web W produced by the pressure roller 132 can be changed to a larger value.

In this example, the support shaft 30 and the four pressure rollers 134 to 137 constitute a first adjusting unit 146, and the support shaft 30 and the four pressure rollers 132, 133, 138, and 139 constitute second adjusting units 147a and 147b.

Therefore, as shown in FIG. 11, when the threaded shafts 49a and 49b are rotated in the positive rotation direction by the driving motors 50a and 50b, the movement blocks 46a and 46b move forward, which enables the eight pressure rollers 132 to 139 to move in the direction toward the web W via the support shaft 30. When the eight pressure rollers 132 to 139 are moved in the direction toward the web W to press the running web W from one surface, parts of the web W pressed by the pressure rollers 132 to 139 project on the other surface side and then the web W becomes wavy. Although the web W is extended widthwise due to the ink and the dampening water supplied during printing, the length in the width direction is reduced because the web W is made wavy by the pressure rollers 132 to 139. Accordingly, the length of the web W can be modified to the one before the printing, that is, the fan-out can be corrected and consequently misregistration between the web W and the print images can be adjusted.

In the lateral register correcting device 131 of the present embodiment, the pressure amounts in the central area in the width direction of the web W and the pressure amounts in the outer areas in the width direction of the web W can be adjusted to different values by the first adjusting unit 146 and the second adjusting units 147a and 147b. Specifically, the pressure amounts in the outer areas in the width direction of the web W are adjusted to be larger than those in the central area in the width direction of the web W.

That is, the pressure rollers 132, 133, 138, and 139 in the second adjusting units 147a and 147 previously change the phase of the eccentric shaft 141 as shown in FIGS. 12A and 12B to change the pressure distance from the rotation center O₁ of the support shaft 30 to the outer peripheral surface of the roller body 142 pressing the web W, thereby setting the projection amounts on the web W produced by the pressure rollers 132, 133, 138, and 139 in the second adjusting units 147a and 147b to be larger than the projection amounts on the web W produced by the pressure rollers 134 to 137 in the first adjusting unit 146 as shown in FIG. 11.

Therefore, the control device causes the driving motors 50a and 50b to rotate the threaded shafts 49a and 49b in the positive rotation direction to move the movement blocks 46a and 46b forward and move all the pressure rollers 132 to 139 in the direction toward the web W via the support shaft 30, thereby pressing the web W with the pressure rollers 132 to 139 to cause the web W to be wavy. At that time, because the projection amounts of the pressure rollers 132, 133, 138, and 139 in the outer areas are larger, the pressure amounts on the web W of the pressure rollers 132, 133, 138, and 139 become larger than those of the pressure rollers 134 to 137 in the central area. Accordingly, although the tensions are lower in the outer areas in the width direction, the web W becomes almost uniformly wavy in the width direction and the length in the width direction is reduced to appropriate one. As a result, the web W has the length in the width direction modified to the one before the printing and the fan-out can be properly corrected.

As described above, the lateral register correcting device according to the sixth embodiment includes the first adjusting unit 146 including the four pressure rollers 134 to 137 arranged in the central area in the width direction of the web W, and the second adjusting units 147a and 147b including the four pressure rollers 132, 133, 138, and 139 arranged in the outer areas in the width direction of the web W. The pressure rollers 132, 133, 138, and 139 in the second adjusting units 147a and 147b are capable of decentering and, by changing the phases thereof, the lateral register correcting device can change the pressure amounts.

Therefore, the pressure amounts (projection amounts) to the web W of the pressure rollers 132, 133, 138, and 139 of the second adjusting units 147a and 147b in the outer areas are set larger than the pressure amounts (projection amounts) of the pressure rollers 134 to 137 of the first adjusting unit 146 in the central area, so that the register adjustment amounts are appropriately adjusted to almost uniform values at all positions in the width direction of the web W where the tensions are different from each other, and the fan-out of the web W can be properly corrected. As a result, the print quality can be improved.

### Seventh Embodiment

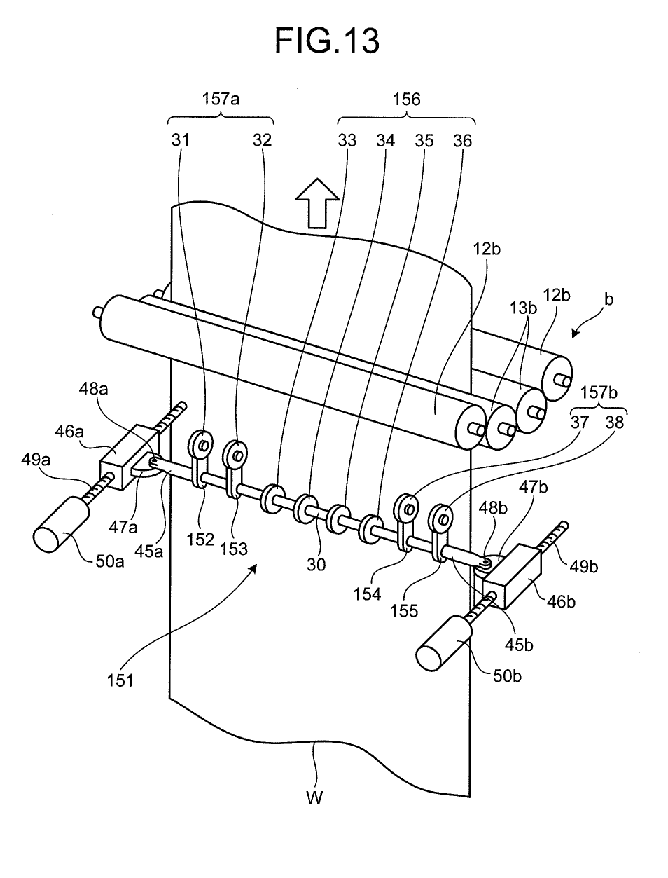

FIG. 13 is a schematic configuration diagram of a lateral register correcting device according to a seventh embodiment of the present invention. Elements having functions identical to those of the embodiments described above are denoted by like reference signs and redundant explanations thereof will be omitted.

In the seventh embodiment, a lateral register correcting device 151 is provided on one surface side of the running web W as shown in FIG. 13. In the lateral register correcting device 151, the support shaft 30 horizontal to the width direction of the web W is arranged in parallel to the web W and the eight pressure rollers 31 to 38 arranged at the regular interval in the entire area (the central area and the outer areas) in the width direction of the web W are rotatably supported on the support shaft 30.

In this example, while all the pressure rollers 31 to 38 have the same outer diameter, the four pressure rollers 31, 32, 37, and 38 arranged in the outer areas in the width direction of the web W are nearer to the plate cylinders 12b and the blanket cylinders 13b located downstream of the web W than the four pressure rollers 33 to 36 arranged in the central area. Specifically, the lateral register correcting device 151 of the present embodiment is located upstream of the stack b in the running direction of the web W, where the four pressure rollers 33 to 36 arranged in the central area are rotatably supported directly on the support shaft 30 and the four pressure rollers 31, 32, 37, and 38 arranged in the outer areas are rotatably supported on the support shaft 30 via links 152 to 155 connected thereto. These links 152 to 155 have ends extending toward the plate cylinders 12b and the blanket cylinders 13b, and the pressure rollers 31, 32, 37, and 38 supported on the ends are located nearer to the plate cylinders 12b and the blanket cylinders 13b than the pressure rollers 33 to 36.

The support shaft 30 and the four pressure rollers 33 to 36 constitute a first adjusting unit 156, and the support shaft 30 and the four pressure rollers 31, 32, 37, and 38 constitute second adjusting units 157a and 157b.

Accordingly, when the threaded shafts 49a and 49b are rotated in the positive rotation direction by the driving motors 50a and 50b, the movement blocks 46a and 46b move forward, which enables the eight pressure rollers 31 to 38 to move in the direction toward the web W via the support shaft 30. When the eight pressure rollers 31 to 38 are moved in the direction toward the web W to press the running web W from one surface, parts of the web W pressed by the pressure rollers 31 to 38 project on the other surface side and thus the web W becomes wavy. Although the web W is extended widthwise due to the ink and the dampening water supplied during printing, the length in the width direction is reduced because the web W is made wavy by the pressure rollers 31 to 38. In this way, the length in the width direction can be modified to the one before the printing, that is, the fan-out can be corrected, and consequently misregistration between the web W and the print images can be adjusted.

In the lateral register correcting device 151 of the present embodiment, the pressure amounts in the central area in the width direction of the web W and the pressure amounts in the outer areas in the width direction of the web W can be adjusted to different values by the first adjusting unit 156 and the second adjusting units 157a and 157b. Specifically, the pressure amounts in the outer areas in the width direction of the web W are adjusted to be larger than the pressure amounts in the central area in the width direction of the web W.

That is, the pressure rollers 31, 32, 37, and 38 of the second adjusting units 157a and 157b are nearer to the plate cylinders 12b and the blanket cylinders 13b located downstream in the running direction of the web W than the pressure rollers 33 to 36 of the first adjusting unit 156. Therefore, the control device causes the driving motors 50a and 50b to rotate the threaded shafts 49a and 49b in the positive rotation direction to move the movement blocks 46a and 46b forward and move all the pressure rollers 31 to 38 in the direction toward the web W via the support shaft 30, thereby pressing the web W with all the pressure rollers 31 to 38 to cause the web W to be wavy.

At that time, although the web W is pressed and made wavy by the pressure rollers 31 to 38 and the fan-out is corrected, the web W is slightly extended widthwise while the web W reaches the plate cylinders 12b and the blanket cylinders 13b due the tensions applied thereto. However, because the pressure rollers 31, 32, 37, and 38 in the outer areas are located nearer to the plate cylinders 12b and the blanket cylinders 13b, the amounts of extension in the web W caused by the pressure with the pressure rollers 31, 32, 37, and 38 are smaller than those caused by the pressure with the pressure rollers 33 to 36. Accordingly, the pressure amounts (projection amounts) of the pressure rollers 31, 32, 37, and 38 in the outer areas are larger than the pressure amounts (projection amounts) of the pressure rollers 33 to 36 in the central area. As a result, while the tensions in the outer areas in the width direction are lower, the web W becomes almost uniformly wavy in the width direction and the length in the width direction is reduced to appropriate one. Consequently, the length of the web W in the width direction is modified to the one before the printing, thereby properly correcting the fan-out.

As described above, the lateral register correcting device according to the seventh embodiment includes the first adjusting unit 156 including the four pressure rollers 33 to 36 arranged in the central area in the width direction of the web W, and the second adjusting units 157a and 157b including the four pressure rollers 31, 32, 37, and 38 arranged in the outer areas in the width direction of the web W, in which the pressure rollers 31, 32, 37, and 38 of the second adjusting units 157a and 157b are positioned nearer to the plate cylinders 12b and the blanket cylinders 13b located downstream in the running direction of the web W than the pressure rollers 33 to 36 of the first adjusting unit 156.

Therefore, the pressure amounts (projection amounts) to the web W of the pressure rollers 31, 32, 37, and 38 of the second adjusting units 157a and 157b in the outer areas are larger than the pressure amounts (projection amounts) of the pressure rollers 33 to 36 of the first adjusting unit 156 in the central area. This enables to appropriately adjust the register adjustment amounts to almost uniform values at all positions in the width direction of the web W where the tensions are different from each other. In this way, the fan-out of the web W can be properly corrected and, as a result, the print quality can be improved.

While the pressure rollers 31, 32, 37, and 38 of the second adjusting units 157a and 157b are positioned nearer to the plate cylinders 12b and the blanket cylinders 13b through the links 152 to 155 in the present embodiment, the present invention is not limited to this configuration. For example, the pressure amounts (projection amounts) of the pressure rollers 31, 32, 37, and 38 in the outer areas can be set larger than the pressure amounts (projection amounts) of the pressure rollers 33 to 36 in the central area by enabling the links 152 to 155 to freely rotate about the support shaft 30 and changing distances between the pressure rollers 31, 32, 37, and 38 and the web W. Furthermore, while the second adjusting units 157a and 157b include the links, thrusting amounts of the pressure rollers 31 to 38 can be adjusted by providing the first adjusting unit and the second adjusting units as separate bodies, arranging the second adjusting units at positions near to the plate cylinders 12b and the blanket cylinders 13b, and driving the second adjusting units separately from the first adjusting unit.

### Eighth Embodiment

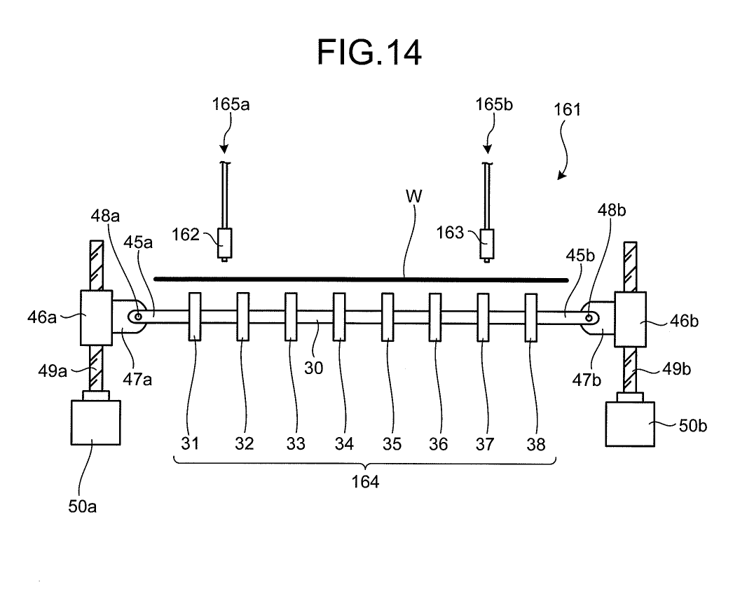

FIG. 14 is a schematic configuration diagram of a lateral register correcting device according to an eighth embodiment of the present invention. Elements having functions identical to those of the embodiments described above are denoted by like reference signs and redundant explanations thereof will be omitted.

In the eight embodiment, a lateral register correcting device 161 is provided on one surface side and the other surface side of the running web W as shown in FIG. 14. On one surface side of the web W, the lateral register correcting device 161 has the support shaft 30 horizontal to the width direction of the web W arranged in parallel to the web W, and the eight pressure rollers 31 to 38 rotatably supported on the support shaft 30 in the entire area (the central area and the outer areas) in the width direction of the web W. In this example, all the pressure rollers 31 to 38 have the same outer diameter and are arranged at the regular interval.

On the other surface side of the web W, two air nozzles 162 and 163 are arranged in the outer areas in the width direction of the web W. The air nozzles 162 and 163 are connected to an air supply source (not shown) and can jet air to the other surface of the web W.

In this example, the support shaft 30 and the eight pressure rollers 31 to 38 constitute a first adjusting unit 164, and the two air nozzles 162 and 163 and the like constitute second adjusting units 165a and 166b.

Therefore, when the threaded shafts 49a and 49b are rotated in the positive rotation direction by the driving motors 50a and 50b, the movement blocks 46a and 46b move forward, thereby moving the eight pressure rollers 31 to 38 in the direction toward the web W via the support shaft 30. When the running web W is pressed from one surface by moving the eight pressure rollers 31 to 38 in the direction toward the web W, parts pressed by the pressure rollers 31 to 38 project on the other surface side and the web W becomes wavy. Accordingly, although the web W is extended widthwise due to the ink and the dampening water supplied during printing, the length in the width direction is reduced because of the wavy form produced by the pressure rollers 31 to 38 and can be modified to the one before the printing. That is, the fan-out can be corrected and consequently misregistration between the web W and the print images can be adjusted.

In the lateral register correcting device 161 of the present embodiment, the pressure amounts in the central area in the width direction of the web W and the pressure amounts in the outer areas in the width direction of the web W can be adjusted to different values by the first adjusting unit 164 and the second adjusting units 165a and 165b. Specifically, the pressure amounts in the outer areas in the width direction of the web W are adjusted to be larger than those in the central area in the width direction of the web W.

That is, the pressure rollers 31 to 38 of the first adjusting unit 164 are arranged at the regular interval in the entire area on one surface side of the web W, and the air nozzles 162 and 163 of the second adjusting units 165a and 165b are arranged in the outer areas on the other surface side of the web W. Accordingly, the control device rotates the threaded shafts 49a and 49b in the positive rotation direction by using the driving motors 50a and 50b to move the movement blocks 46a and 46b forward and move all the pressure rollers 31 to 38 in the direction toward the web W via the support shaft 30, thereby pressing the web W on one surface with the pressure rollers 31 to 38 to cause the web W to be wavy. While the length of the web W in the width direction is reduced due to the wavy form in the entire area in the width direction, the waves in the outer areas in the width direction are smaller because the tensions are lower in the outer areas.

Accordingly, the control device causes the air nozzles 162 and 163 to jet air toward the other surface side of the web W, thereby pressing only the outer areas of the web W with the jetted air to form waves in these areas. While the tensions are lower in the outer areas in the width direction, the web W becomes almost uniformly wavy in the width direction and has a length in the width direction reduced to appropriate one because the pressure amounts (projection amounts) of the pressure rollers 31, 32, 37, and 38 and the jetted air from the air nozzles 162 and 163 are larger than the pressure amounts (projection amounts) of the pressure rollers 33 to 36 in the central area. As a result, the length in the width direction of the web W is modified to the one before the printing and the fan-out can be properly corrected.

As described above, the lateral register correcting device according to the eighth embodiment includes the first adjusting unit 164 including the eight pressure rollers 31 to 38 arranged on one surface side of the web W in the entire area in the width direction, and the second adjusting units 165a and 165b including the two air nozzles 162 and 163 arranged on the other surface side of the web W in the outer areas in the width direction.

Therefore, with respect to the web W, the pressure amounts (projection amounts) of the pressure rollers 31, 32, 37, and 38 of the first adjusting unit 164 and the jetted air from the air nozzles 162 and 163 of the second adjusting units 165a and 165b in the outer areas are larger than the pressure amounts (projection amounts) of the pressure rollers 33 to 36 of the first adjusting unit 164 in the central area. This enables to appropriately adjust the register adjustment amounts to almost uniform values at all positions in the width direction of the web W where the tensions are different from each other and properly correct the fan-out of the web W, resulting in an improved print quality.

Furthermore, in the lateral register correcting device according to the eighth embodiment, the pressure rollers 31 to 38 of the first adjusting unit 164 are arranged at the regular interval in the central area and in the outer areas on one surface side of the web W, and the air nozzles 162 and 163 of the second adjusting units 165a and 165b are arranged in the outer areas on the other surface side of the web W. Therefore, the second adjusting units 165a and 165b can be arranged out of the way of the first adjusting unit 164, which simplifies the configuration.

While the pressure rollers are applied to the first adjusting unit and the pressure rollers or the air nozzles are applied to the second adjusting units as the pressing members in the respective embodiments described above, the air nozzles can be applied to the first adjusting unit. All the pressing members can be the air nozzles. Furthermore, the pressing members are not limited to the pressure rollers and the air nozzles but can be a pressing plate, a slit nozzle, or the like. The pressing members can be provided not only on one side surface of the web W but also on the other surface side of the web W. While the driving devices of the pressure rollers are configured by the driving motors 50a and 50b and the threaded shafts 49a and 49b, the driving devices can be a rack-and-pinion mechanism, a hydraulic pressure or air cylinder mechanism, or the like.

While four pressing members are included in the first adjusting unit and two or three pressing members are included in the second adjusting units on either side in the respective embodiments described above, the present invention is not limited to these numbers but the number of the pressing members can be appropriately set according to the width of the web W or the like. In such cases, while plural pressing members are required in the first adjusting unit in the central area, the number of pressing members can be one in the second adjusting units in the outer areas and the pressing member is not necessarily placed in the outermost area.

### Ninth Embodiment

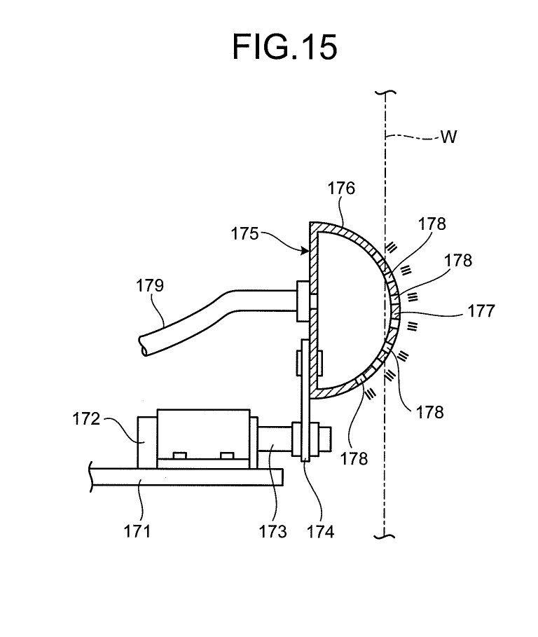

FIG. 15 is a schematic diagram of a pressing member in a lateral register correcting device according to a ninth embodiment of the present invention.

The lateral register correcting device according to the ninth embodiment represents a modification of the pressing members in the respective embodiments described above, and has a configuration including the pressure rollers and the air nozzles. That is, as shown in FIG. 15, a support frame 171 is provided in a hanging manner in the width direction of the running web W (direction perpendicular to the drawing sheet of FIG. 15), and an actuator 172 is fixed on the support frame 171. The actuator 172 has a driving rod 173 extending toward one surface side of the web W and has a pressure block 175 as a pressing member attached via an attachment bracket 174 on one end.

In the pressure block 175, a block body (pressing member body) 176 is hollow in shape, has a predetermined thickness in the width direction of the web W, and has a curved surface 177 formed at a front part facing the running web W. The curved surface 177 has a central axis in the width direction of the web W and is approximately semicircular in shape. Many ejection holes 178 for jetting air (fluid) contained in the block body 176 toward the web W are formed on the curved surface 177. An air supply pipe 179 is connected to the block body 176.

A plurality of, or eight, for example, pressure blocks 175 are provided on one surface side of the web W at a predetermined interval in the width direction.

Therefore, when the web W runs upward, air is supplied inside of the pressure blocks 175 to jet the air through the many ejection holes 178, and the pressure blocks 175 are moved in the direction toward the web W by the actuators 172. The curved surfaces 177 of the pressure blocks 175 then press the running web W from one surface, and parts pressed by the pressure blocks 175 project on the other surface side to cause the web W to be wavy. At that time, the air is jetted through the many ejection holes 178 on the curved surface 177 of the pressure blocks 175 and accordingly the curved surface 177 does not directly contact with the surface of the web W, which prevents damage of the web W or degradation of the print surface.

While the web W is extended widthwise due to the ink and the dampening water supplied during printing, the length in the width direction is reduced and can be modified to the one before the printing because the web W is made wavy by the pressure blocks 175. That is, the fan-out can be corrected and consequently misregistration between the web W and the print images can be adjusted.

As described above, in the lateral register correcting device according to the ninth embodiment, each of the pressure blocks 175 includes the block body 176 being hollow in shape and having the curved surface 177 with the central axis along the width direction of the web W, and the many ejection holes 178 formed on the curved surface 177 to jet air contained in the pressure block body 176 toward the web W.

Therefore, when the curved surfaces 177 of the pressure blocks 175 press the web W to correct the fan-out, there is air between the curved surfaces 177 of the pressure blocks 175 and the web W, which implies that the curved surfaces 177 never contact with the surface of the web W. Accordingly, damage of the web W or degradation of the print surface can be prevented, an appropriate wavy form can be provided, and the fan-out can be corrected.

While the many ejection holes 178 are formed on the curved surface 177 of the block body 176 of each of the pressure blocks 175 in the ninth embodiment, the present invention is not limited to the number and it suffices that one or more ejection holes 178 are formed thereon.

### Tenth Embodiment

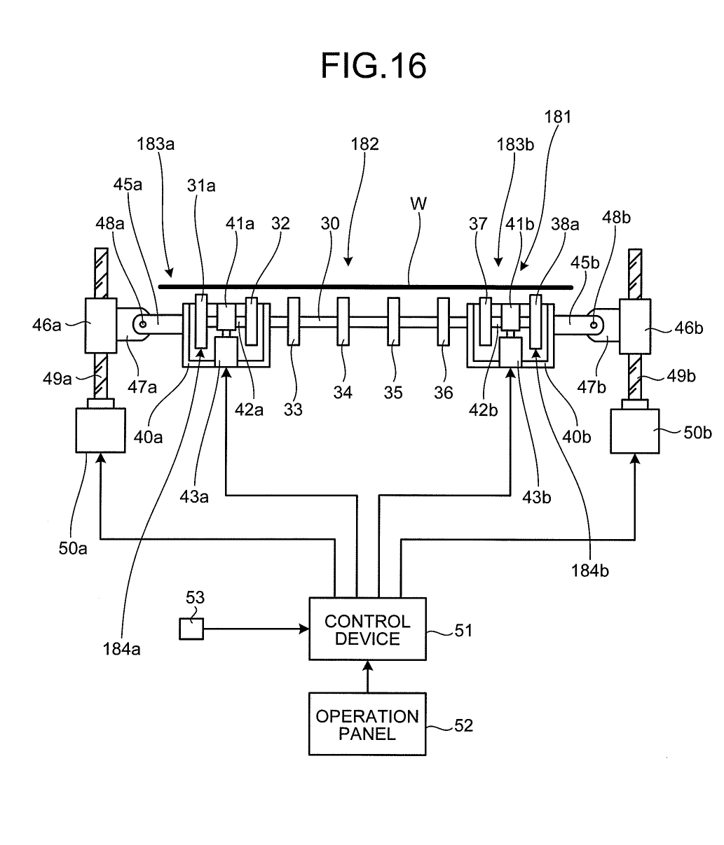

FIG. 16 is a schematic configuration diagram of a lateral register correcting device according to a tenth embodiment of the present invention. Elements having functions identical to those of the embodiments described above are denoted by like reference signs and redundant explanations thereof will be omitted.

In the tenth embodiment, a lateral register correcting device 181 is provided on one surface side of the running web W as shown in FIG. 16. In the lateral register correcting device 181, the support shaft 30 horizontal to the width direction of the web W is arranged in parallel to the web W, and eighth pressure rollers 31a, 32 to 37, and 38a are provided on the support shaft 30 at a regular interval.

The four pressure rollers 33 to 36 arranged in the central area in the width direction of the web W are rotatably supported on the support shaft 30. In this example, the support shaft 30 and the four pressure rollers 33 to 36 constitute a first adjusting unit 182. On the other hand, in the outer areas in the width direction of the web W than the central area in the width direction of the web W, the cases 40a and 40b are fixed at axial ends of the support shaft 30, and the cases 40a and 40b have the movement members 41a and 41b movably supported thereon and the pressure rollers 31a, 32, 37, and 38a rotatably supported thereon via the support shafts 42a and 42b. The movement members 41a and 41b are enabled to reciprocate by the actuators 43a and 43b.

In the present embodiment, the two pressure rollers 31a and 38a arranged on outermost sides have an outer diameter set larger than that of the six pressure rollers 32 to 37. In this example, the cases 40a and 40b, the movement members 41a and 41b, the support shafts 42a and 42b, and the pressure rollers 31a, 32, 37, and 38a constitute second adjusting units 183a and 183b, which are arranged in the outer areas in the width direction of the web W than the first adjusting unit 182. Furthermore, the pressure rollers 31a and 38a constitute third adjusting units 184a and 184b. The actuators 43a and 43b function as second and third driving devices according to the present invention.

Therefore, when the threaded shafts 49a and 49b are rotated in the positive rotation direction by the driving motors 50a and 50b, the movement blocks 46a and 46b move forward, thereby moving the eight pressure rollers 31a, 32 to 37, and 38a in the direction toward the web W via the cases 40a and 40b, the support shaft 30, and the like. The four pressure rollers 31, 32, 37, and 38 can be moved by the actuators 43a and 43b in the direction toward the web W via the movement members 41a and 41b, and the like.

When the eight pressure rollers 31a, 32 to 37, and 38a are moved in the direction toward the web W to press the running web W from one surface, parts of the web W pressed by the pressure rollers 31a, 32 to 37, and 38a project on the other surface side, which causes the web W to be wavy. While the web W is extended widthwise due to the ink and the dampening water supplied during printing, the length in the width direction is reduced and modified to the one before the printing because the web W is made wavy by the pressure rollers 31 to 38. That is, the fan-out can be corrected and consequently misregistration between the web W and the print images can be adjusted.

In the lateral register correcting device 181 of the present embodiment, the pressure amounts in the central area in the width direction of the web W, the pressure amounts in the outer areas in the width direction of the web W, and the pressure amounts on the outermost sides in the width direction of the web W can be adjusted to different values by the first adjusting unit 182, the second adjusting units 183a and 183b, and the third adjusting units 184a and 184b. Specifically, the pressure amounts in the outer areas in the width direction of the web W are adjusted to be larger than those in the central area in the width direction of the web W, and the pressure amounts on the outermost sides in the width direction of the web W are adjusted to be larger than those in the outer areas in the width direction of the web W.

That is, the control device 51 moves only the four pressure rollers 31a, 32, 37, and 38 in the direction toward the web W by using the actuators 43a and 43b, thereby pressing only the outer areas of the web W with the pressure rollers 31a, 32, 37, and 38a to cause the outer areas to be wavy. While the tensions are lower in the outer areas of the web W in the width direction, the pressure amounts (projection amounts) of the pressure amounts 31a, 32, 37, and 38a become larger than the pressure amounts (projection amounts) of the pressure rollers 33 to 36 in the central area. The pressure rollers 31a and 38a of the second adjusting units 184a and 184b have the outer diameter set larger than that of the pressure rollers 32 and 37. Accordingly, the pressure amounts (projection amounts) of the pressure rollers 31a and 38a become larger than the pressure amounts (projection amounts) of the pressure rollers 32 and 37. As a result, the web W becomes almost uniformly wavy in the width direction and the length in the width direction is reduced to appropriate one. Consequently, the length of the web W in the width direction is modified to the one before the printing and the fan-out can be properly corrected.

As described above, the lateral register correcting device 181 according to the tenth embodiment includes the first adjusting unit 182 including the four pressure rollers 33 to 36 arranged in the central area in the width direction of the web W, the second adjusting units 183a and 183b including the four pressure rollers 31a, 32, 37, and 38a arranged in the outer areas in the width direction of the web W than the first adjusting unit 182, and the third adjusting units 184a and 184b including the two pressure rollers 31a and 38a arranged on the outermost sides in the width direction of the web W, in which the respective pressure amounts can be adjusted to different values (the adjusting system).

Accordingly, with respect to the web W, the pressure amounts in the central area, the pressure amounts in the outer areas, and the pressure amounts on the outermost sides are adjusted to the different values by the first adjusting unit 182, the second adjusting units 183a and 183b, and the third adjusting units 184a and 184b. This enables to appropriately adjust the register adjustment amounts to almost uniform values at all positions in the width direction of the web W where the tensions are different from each other, properly correct the fan-out of the web W, and consequently improve the print quality. That is, because the fan-out amounts of the web W are largest on the outermost sides in the width direction, the fan-out can be properly corrected by providing the third adjusting units 184a and 184b.

While the third adjusting units 184a and 184b are configured by the pressure rollers 31a and 38a having the larger outer diameter in the tenth embodiment, the present invention is not limited to this configuration. For example, it is possible that the pressure rollers 31a, 32, 37, and 38a have the same diameter, and the pressure rollers 31a and 38a and the third driving devices that move the pressure rollers 31a and 38a are provided as the third adjusting units. It is also possible to configure the second adjusting units by the two pressure rollers 32 and 37 and the third adjusting units by the two pressure rollers 31a and 38a, and provide the second driving devices that move the pressure rollers 32 and 37 and the third driving devices that move the pressure rollers 31a and 38a. Furthermore, the third adjusting units can be the air nozzles.

### INDUSTRIAL APPLICABILITY

The folder according to the present invention can adjust the pressure amounts in the central area in the width direction of the web and the pressure amounts in the outer areas in the width direction of the web W to different values, thereby properly correcting the fan-out of the web to improve the print quality, and can be applied to any type of printing press.

### REFERENCE SIGNS LIST

R feeder device
R1 to R8 feeder unit
U printing device
U1 to U6, U11 to U62 printing unit
D web path device
D1, D2 web path unit
F folder
F1, F2 folder unit
21, 22, 23, 61, 71, 91, 111, 131, 151, 161, 181 lateral register correcting device
31 to 38, 92 to 99, 112 to 121, 132 to 139, 31a, 38a pressure roller (pressing member)
39, 62, 85, 100, 122, 146, 156, 164, 182 first adjusting unit
40a, 40b case
43a, 43b actuator (second driving device, third driving device)
44a, 44b, 66a, 66b, 86a, 86b, 101a, 101b, 123a, 123b, 147a, 147b, 157a, 157b, 165a, 165b, 183a, 183b second adjusting unit
50a, 50b driving motor (first driving device)
51 control device
63a, 63b, 162, 163 air nozzle
65a, 65b pressure reducing valve (second driving device)
78, 79 actuator (first driving device)
77, 80 actuator (second driving device)
141 eccentric shaft
142 roller body
152 to 155 link
175 pressure block (pressing member)
184a, 184b third adjusting unit
W web

1. A lateral register correcting device that adjusts register in a width direction of a web by pressing a plurality of pressing members provided in the width direction of the web against the running web at least from one surface thereof to cause the web to be wavy, the lateral register correcting device comprising:
a first adjusting unit that comprises a plurality of the pressing members arranged in a central area in the width direction of the web;
a second adjusting unit that comprises one or more of the pressing members arranged in an outer area in the width direction of the web than the first adjusting unit; and
an adjusting system that can adjust a pressure amount in the central area in the width direction of the web and a pressure amount in the outer area in the width direction of the web to different values through the first and second adjusting units, wherein
the pressing members are pressure rollers in a disc shape, and the pressure rollers of the second adjusting unit have an outer diameter set larger than that of the pressure rollers of the first adjusting unit.

2. The lateral register correcting device according to claim 1, wherein the adjusting system adjusts the pressure amount in the outer area in the width direction of the web to be larger than the pressure amount in the central area in the width direction of the web.

3. The lateral register correcting device according to claim 1, wherein the adjusting system has a first driving device and a second driving device that can independently drive the first and second adjusting units, respectively

4. (canceled)

5. (canceled)

6. The lateral register correcting device according to claim 1, wherein the pressing members are pressure rollers in a disc shape, and number of the pressure rollers per unit length in the second adjusting unit is set larger than number of the pressure rollers per unit length in the first adjusting unit.

7. The lateral register correcting device according to claim 1, wherein the pressing members are pressure rollers in a disc shape, and the pressure rollers in the second adjusting unit each have a roller body rotatably supported on an eccentric shaft and can change the pressure amount by changing a phase of the eccentric shaft.

8. The lateral register correcting device according to claim 1, wherein a third adjusting unit comprising one of the pressing members arranged on an outermost side in the width direction of the web is comprised, and the adjusting system can adjust a pressure amount in a central area in the width direction of the web, a pressure amount in an outer area in the width direction of the web, and a pressure amount on the outermost side in the width direction of the web to different values through the first, second, and third adjusting units.

9. The lateral register correcting device according to claim 1, wherein the plurality of pressing members are located upstream in the web running direction with respect to a printing cylinder, and the pressing members in the second adjusting unit are located nearer to the printing cylinder than the pressing members in the first adjusting unit.

10. The lateral register correcting device according to claim 1, wherein the first adjusting units are arranged at a regular interval in the central area and in the outer area on one surface side of the web, and the second adjusting unit is arranged in the outer area on the other surface side of the web.

11. The lateral register correcting device according to claim 1, wherein the pressing members each have a pressing member body in a hollow shape having a curved surface around a central axis along the width direction of the web, and an ejection hole formed on the curved surface to jet fluid contained in the pressing member body toward the web.

12. The lateral register correcting device according to claim 1, wherein the adjusting system has a control unit that can control the adjusting units, and the control unit controls the adjusting units based on web data or print data previously set.

13. The lateral register correcting device according to claim 1, wherein the adjusting system comprises a control unit that can control each of the adjusting units, and a misalignment detecting unit that detects misalignment between the web and print images, and the control unit controls the adjusting units based on a result of detection by the misalignment detecting unit.

14. A printing press comprising:
a feeder device that feeds a web from rolled paper;
a printing device that comprises a plurality of printing units each performing printing on the web let out from the feeder device;
a folder that cuts the web subjected to the printing by the printing device, and superimposes and folds the webs, thereby forming a signature; and
a lateral register correcting device that adjusts register in a width direction of the web by pressing a plurality of pressing members provided in the width direction of the web between the plurality of printing units against the running web at least from one surface thereof to cause the web to be wavy,
the lateral register correcting device comprising:
a first adjusting unit that comprises a plurality of the pressing members arranged in a central area in the width direction of the web;
a second adjusting unit that comprises one or more of the pressing members arranged in an outer area in the width direction of the web than the first adjusting unit; and
an adjusting system that can adjust a pressure amount in the central area in the width direction of the web and a pressure amount in the outer area in the width direction of the web to different values through the first and second adjusting units, wherein
the pressing members are pressure rollers in a disc shape, and the pressure rollers of the second adjusting unit have an outer diameter set larger than that of the pressure rollers of the first adjusting unit.

15. The printing press according to claim 14, comprising a plate cylinder having press plates attached thereto, and a blanket cylinder facing in contact with the plate cylinder to transfer ink on the plate cylinder to the web, wherein the plate cylinder is an integrated plate cylinder to which a plurality of the press plates can be attached on an outer peripheral surface along an axial direction thereof and that can adjust positions of the press plates with respect to the web by being axially moved with respect to a frame.

16. A lateral register correcting device that adjusts register in a width direction of a web by pressing a plurality of pressing members provided in the width direction of the web against the running web at least from one surface thereof to cause the web to be wavy, the lateral register correcting device comprising:
a first adjusting unit that comprises a plurality of the pressing members arranged in a central area in the width direction of the web;
a second adjusting unit that comprises one or more of the pressing members arranged in an outer area in the width direction of the web than the first adjusting unit; and
an adjusting system that can adjust a pressure amount in the central area in the width direction of the web and a pressure amount in the outer area in the width direction of the web to different values through the first and second adjusting units, wherein
the adjusting system has a first driving device that can drive the first and second adjusting units together, and a second driving device that can drive only the second adjusting unit.

17. A printing press comprising:
a feeder device that feeds a web from rolled paper;
a printing device that comprises a plurality of printing units each performing printing on the web let out from the feeder device;
a folder that cuts the web subjected to the printing by the printing device, and superimposes and folds the webs, thereby forming a signature; and
a lateral register correcting device that adjusts register in a width direction of the web by pressing a plurality of pressing members provided in the width direction of the web between the plurality of printing units against the running web at least from one surface thereof to cause the web to be wavy,
the lateral register correcting device comprising:
a first adjusting unit that comprises a plurality of the pressing members arranged in a central area in the width direction of the web;
a second adjusting unit that comprises one or more of the pressing members arranged in an outer area in the width direction of the web than the first adjusting unit; and
an adjusting system that can adjust a pressure amount in the central area in the width direction of the web and a pressure amount in the outer area in the width direction of the web to different values through the first and second adjusting units, wherein
the adjusting system has a first driving device that can drive the first and second adjusting units together, and a second driving device that can drive only the second adjusting unit.

18. The lateral register correcting device according to claim 16, wherein the pressing members are pressure rollers in a disc shape, and number of the pressure rollers per unit length in the second adjusting unit is set larger than number of the pressure rollers per unit length in the first adjusting unit.

19. The lateral register correcting device according to claim 16, wherein the pressing members are pressure rollers in a disc shape, and the pressure rollers in the second adjusting unit each have a roller body rotatably supported on an eccentric shaft and can change the pressure amount by changing a phase of the eccentric shaft.

20. The lateral register correcting device according to claim 16, wherein the plurality of pressing members are located upstream in the web running direction with respect to a printing cylinder, and the pressing members in the second adjusting unit are located nearer to the printing cylinder than the pressing members in the first adjusting unit.

21. The lateral register correcting device according to claim 16, wherein the first adjusting units are arranged at a regular interval in the central area and in the outer area on one surface side of the web, and the second adjusting unit is arranged in the outer area on the other surface side of the web.

22. The lateral register correcting device according to claim 16, wherein the pressing members each have a pressing member body in a hollow shape having a curved surface around a central axis along the width direction of the web, and an ejection hole formed on the curved surface to jet fluid contained in the pressing member body toward the web.
